(19) United States
(12) Patent Application Publication
(10) Pub. No.: US 2007/0286471 A1
(43) Pub. Date: Dec. 13, 2007

(54) Auto Distinction System And Auto Distinction Method

(76) Inventors: Hiroshi Kaneda, Himeji-shi (JP); Masaki Takebe, Himeji-shi (JP)

Correspondence Address: BIRCH STEWART KOLASCH & BIRCH, PO BOX 747, FALLS CHURCH, VA, 22040-0747, US

(21) Appl. No.: 11/667,625

(22) PCT Filed: Nov. 15, 2005
(86) PCT No.: PCT/JP05/20929

§ 371 Date: May 11, 2007

(30) Foreign Application Priority Data
Nov. 19, 2004 (JP) 2004-336735

(51) Int. Cl. G01N 21/88

(52) U.S. Cl. 382/141

(57) ABSTRACT

The present invention provides an auto distinction system and an auto distinction method with which suitability of a width, a thickness, and a stain of a continuously moving assembled fiber band can be accurately distinguished. An assembled fiber band such as a filter tow which continuously moves on the front side of a background plate is imaged by a line sensor. Based on the produced video signal, a characteristic information containing a defect information concerning a thickness, a width, and a stain of the assembled fiber band is detected, and the defect information is extracted from the characteristic information. Thus suitability of the assembled fiber band is distinguished. For example, the video signal is supplied to a noise-eliminating circuit 6a and a defect signal concerning the thickness of the assembled fiber band is extracted. Based on the extracted signal and a reference signal with respect to the information, suitability of the defect information is distinguished by a distinction circuit 7. When the results of distinction are defective, the results are announced by an annunciation circuit 8. The video signal may be clamped by a clamping circuit 5b, and based on the clamped video signal, the defect information of the assembled fiber band may be extracted. The characteristic information or the defect information may be supplied to an external computer and used for process control.

### TECHNICAL FIELD

The present invention relates to an auto distinction system which detects a characteristic information including a defect information of a continuously moving assembled fiber band (for example, a fiber bundle or a fiber assembly such as a filter tow) and which is useful for quality control of the assembled fiber band with time on the basis of the defect information or time sequence (TSEQ) fluctuation information; and relates to an auto distinction method.

### BACKGROUND ART

A video signal (an image signal) from an imaging means is used for quality control and distinguishing whether an inspection target is non-defective or defective. For example, the specification of Japanese Patent No. 3013903 (Patent Document 1) discloses a defect-sensing device for detecting a defect on edges of a flat glass having seaming surfaces obtained by chamfering the edges, in which the device detects on the edges of the glass placed horizontally; wherein the device comprises a light source for irradiating the edge with light from the upper diagonal and the lower diagonal directions opposite side of the flat glass, and at least two cameras which are disposed outside of the extended ranges of light paths irradiated onto the glass edge; and the device images the edge via transparent portions of the flat glass from the opposite sides of the light irradiation directions. The defect-sensing device distinguishes a weathering or burn-in defect based on the level of a brightness signal of an image signal picked up by the cameras. However, this device requires a plurality of light sources and a plurality of imaging means.

The specification of Japanese Patent No. 3025833 (Patent Document 2) discloses an inspection system comprising a signal pattern generating unit, a threshold pattern generating means, and a comparing means. The generating unit generates at least one signal pattern selected from (a) a signal pattern in which a maximum value of a video signal pattern is offset by an offset thereof and (b) a signal pattern in which a minimum value of a video signal pattern is offset by an offset thereof, wherein the video signal patterns are obtained by imaging a non-defective product with an imaging means. The threshold pattern generating means generates threshold patterns from the offset signal patterns. The comparing means distinguishes quality (or good or bad) of an inspection target by comparing a video signal obtained by imaging the inspection target with threshold patterns. Japanese Patent Application Laid-open No. 122269/1996 (JP-A-H8-122269, Patent Document 3) discloses an image pickup type inspection system comprising an imaging means which outputs a video signal by imaging an inspection target, an inspection area setting means for setting an inspection area in the imaged field through the imaging means, an abnormal portion detecting means for detecting an abnormal portion on the basis of the video signal within the inspection area, and a non-defective/defective distinction signal outputting means for outputting a non-defective/defective distinction signal according to whether or not an abnormal portion has been detected, wherein these means are housed in one casing. This document also mentions that the image pickup type inspection system further comprises an annunciation means (or, annunciating means) for announcing the results of non-defective/defective distinction to the outside by means of light or sound.

However, when these systems are applied to an assembled fiber band which is continuously moving or running, it becomes difficult to accurately detect defects such as stains and unevenness of thick or thin portions, because not only does an inspection target continuously move, but also the width and thickness of the assembled fiber band fluctuate by continuous moving. In particular, when the systems are applied to a fiber bundle such as a filter tow which comprises a plurality of yarns and moves at a high speed, not only does the degree of adjacency or overlapping of yarns fluctuates, but also these fluctuations further change every moment while the yarns are moving. Accordingly it becomes difficult to accurately detect defects (or uneven portions) of the assembled fiber band or the fiber pieces.

Japanese Patent Application Laid-open No. 50906/1994 (JP-A-H6-50906, Patent Document 4) discloses an on-line formation tester comprising a means for illuminating a light to a measuring object, a one-dimensional imaging means for imaging a light intensity transmitted through the object, an image memory for storing the image data as an input data, a means for calculating a formation value from a recorded data, and a means for forming a two-dimensional image of a formation pattern from a data accumulated in the image memory. This document also describes that formation is digitized by photographing a moving web with a CCD image sensor, taking in the photographed image continuously, and analyzing one screen (image). However, this formation tester is for forming an image taken in a frame memory to calculate a formation index of a whole image. Accordingly, the formation tester can neither efficiently nor quickly distinguish suitability (or appropriateness) of a defect information of an assembled fiber band sequentially.

Japanese Patent Application Laid-Open No. 158221/1996 (JP-A-H8-158221, Patent Document 5) mentions an image processing method which comprises photographing a tow band with time (or in time series), taking in an arbitrary (or optional) scanning line of each photographed image at a predetermined time interval, taking out an illuminance information of the width direction of the tow band, and quantifying the evenness of thickness of the tow band and the filamentation state thereof based on the illuminance information. In this image processing method, however, it is necessary to take in and calculate the scanning line, and quantify the calculated data as a predetermined parameter. Accordingly, suitability of the defect information concerning the assembled fiber band cannot be distinguished efficiently with a high accuracy in time series. That is, in this image processing method, since it is necessary to digitize the scanning line by a digital oscilloscope and then temporarily store the digitized data in a memory of the digital oscilloscope, a device equipped with the memory is required. Moreover, in this image processing method, a light part and a dark part are distinguished by only one threshold with respect to the digitized data, and the dark part is analyzed as a measuring object unconditionally by a computer and is stored therein. Therefore, the method cannot conduct an advanced processing such as selection and sorting of a measuring object, and in addition, requires a computer.

[Patent Document 1] Specification of Patent Document No. 3013903

[Patent Document 2] Specification of Patent Document No. 3025833

[Patent Document 3] JP-A-H8-122269

[Patent Document 4] JP-A-H6-50906

[Patent Document 5] JP-A-H8-158211

### DISCLOSURE OF THE INVENTION

### Problems to be Solved by the Invention

Therefore, an object of the present invention is to provide an auto distinction system which can distinguish suitability of an assembled fiber band with time by accurately extracting defective portions or uneven portions of the assembled fiber band (or the fiber assembly) even when the assembled fiber band continuously moves, and is useful for transmitting (or sending) or transferring to a computer a characteristic information containing a defect information with respect to the defective portions or the uneven portions as a time sequence or a time-series fluctuation information; and an auto distinction method thereof.

Another object of the present invention is to provide an auto distinction system which can distinguish suitability of the assembled fiber band with time by extracting or detecting a defect information (or a characteristic information including at least a defect information) concerning at least two characteristics selected from a width, a thickness, and a stain of the assembled fiber band; and an auto distinction method thereof.

Still another object of the present invention is to provide a system which efficiently extracts or detects fluctuations in a width, a thickness and a stain of an assembled fiber band with time even when the assembled fiber band is a band-shaped assembled fiber band such as a filter tow which moves or runs at a high speed, and a method thereof.

Still another object of the present invention is to provide an auto distinction system useful for process control and quality control at a production site, wherein a characteristic information of an assembled fiber band is accurately detected by the system even when the assembled fiber band continuously moves, and further a defect information (extracted signal and/or data) extracted from the characteristic information (detection signal) is transferred to a computer (for example, a process control computer) and used as a time sequence fluctuation information (time-series fluctuation information); and an auto distinction method thereof.

### Means to Solve the Problems

The inventors of the present invention did intensive investigation to accomplish the above objects, and finally found that, when (1) an assembled fiber band which continuously moves (or runs) is imaged by a line sensor (line sensor camera), (2) a defect information (or a defect signal) on the width, the thickness and/or the stain of the assembled fiber band is extracted from a characteristic information by an extracting means based on a video signal (image signal, video image signal, luminance signal) from the line sensor or a clamped video signal of the video signal from the line sensor and (3) the defect information (or the defect signal) is compared with a reference value with respect to the defect information (or the defect signal), (a) suitability of the assembled fiber band is accurately distinguished with time (or sequentially) and (b) use of time sequence or time-series fluctuations of the characteristic information is effective for process control and quality control. The present invention was accomplished based on the above findings.

That is, the auto distinction system of the present invention is transmittable to a computer a characteristic information containing a defect information concerning at least one characteristic selected from the group consisting of a width, a thickness, and a stain of a continuously moving assembled fiber band as a time sequence or time-series fluctuation information. This system comprises a line sensor for imaging the continuously moving assembled fiber band; an extracting means for extracting the defect information concerning at least one characteristic (sometimes referred to as a defection or abnormal portion) selected from the group consisting of the width, the thickness, and the stain of the assembled fiber band from the characteristic information based on a video signal from the line sensor; and a distinction means for distinguishing (or discriminating) suitability of the defect information based on an extracted signal from the extracting means and a reference signal with respect to the information (the extracted or detected characteristic information or defect information).

In this system, the characteristic information may be detected and the defect information may be extracted by using a luminance signal in the video signal. In this system, the video signal from the line sensor may be clamped. That is, this system may comprise a clamping means for clamping the video signal from the line sensor in response to a sync-clamping signal. The defect information concerning at least one characteristic selected from the group consisting of the width, the thickness, and the stain of the assembled fiber band may be extracted based on the clamped video signal from the clamping means. Since the video signal sent from the line sensor is usually DC-coupled, it is not necessarily needed to clamp the video signal. However, since the reference level fluctuates even in the case of being DC-coupled, the reference level may be made constant by clamping the video signal with the clamping means. By making the reference level constant, the extraction of the defect information concerning the width, the thickness, and the stain of the assembled fiber band, and the non-defective or defective distinction of the assembled fiber band can be conducted with a high degree of accuracy. Incidentally, the video signal may be, for example, clamped based on the sync-clamping signal by the clamping means. The sync-clamping signal may be generated based on a synchronizing signal, for example, by a sync-clamping signal generating means.

In order to enhance the imaging contrast of the assembled fiber band by the line sensor as well as to enhance the accuracy of detection of the defective portion, the above-mentioned system may have an illuminating means that is disposed outside of a visual field (out-of-view field) of the line sensor and is for illuminating the assembled fiber band, and a background plate for forming the background of the assembled fiber band for the illuminating means. This background plate may have a high contrast color to the assembled fiber band, or may have a color similar to that of the assembled fiber band, or a low contrast color (or substantially the same contrast color with that of the assembled fiber band). When the background plate has a high contrast color in comparison with the assembled fiber band, the extracting means can extract a defect information concerning at least one characteristic selected from a width and a thickness of the assembled fiber band by using a video signal corresponding to the region having the high contrast color. On the other hand, when the background plate has a color similar to that of the assembled fiber band or has a low contrast color in comparison with the assembled fiber band, the extracting means can extract a defect information concerning at least one characteristic selected from a stain and a thickness of the assembled fiber band by using a video signal corresponding to the similar color region. A thickness fluctuation (or defect information) of the assembled fiber band can be detected in both cases of low contrast and high contrast colors of the background plate as long as the background plate color is even.

Incidentally, the assembled fiber band may be an assembled fiber band comprising a plurality of yarns (or strands), for example, a plurality of yarns which are bundled and adjacently arrayed each other [e.g., a band-shaped or ribbon shaped assembled fiber band (band-shaped tow band)], or may be an assembled fiber band comprising a tow band in which yarns are adjacently arrayed each other and overlapped to form a plurality of layers [for example, a band-shaped assembled fiber band (e.g., a filter tow (a cigarette filter tow))]. Furthermore, the assembled fiber band may be usually an assembled fiber band through which a light ray transmits, or may be openable. Incidentally, as long as the illumination means exists out of visual field (out-of-view field) of the line sensor, the illuminating means may illuminate the assembled fiber band from the front side and/or the back side of the assembled fiber band, or the illuminating means may illuminate the assembled fiber band by transmitting a light beam through the assembled fiber band. The present invention is useful for extracting a defect information concerning at least one characteristic selected from a width, a thickness, and a stain of a non-crimped or crimped band-shaped filter tow which continuously moves and comprises a plurality of yarns by an extracting means.

The auto distinction system may comprise an extracting means for extracting a low frequency signal of the video signal which may be clamped, or an extracting means for eliminating a video signal with respect to the thickness (a thickness video signal) by at least a noise elimination means (e.g., a means for eliminating high frequency noise), or may comprise a distinction means for distinguishing suitability of the thickness by comparing the low frequency signal or the thickness video signal with reference values with respect to the lower limit and the upper limit of the thickness.

Further, the auto distinction system may comprise an extracting means for extracting the defect information concerning the thickness, the width and/or the stain of the assembled fiber band from the video signal, and a distinction means for distinguishing suitability of the assembled fiber band by comparing the extracted defect information with a reference signal (or a reference value) with respect to the above characteristic. The auto distinction system may further comprise a sync-clamping signal generating means for generating a sync-clamping signal based on a synchronizing signal, and a clamping means for clamping the video signal in response to the signal from the sync-clamping signal generating means. In the extracting means, the defect signal concerning the thickness, the width and/or the stain of the assembled fiber band may be extracted from the generated clamped video signal.

More specifically, the system may comprise an extracting means for extracting a thickness video signal [a characteristic information (a fluctuation information) of a thickness] from the video signal which may be clamped of the assembled fiber band, a thickness distinction means for distinguishing suitability of the thickness by comparing the thickness video signal with a reference value with respect to the thickness of the assembled fiber band; an extracting means for extracting a width signal from the video signal which may be clamped of the assembled fiber band, a width distinction means for distinguishing suitability of the width by comparing the extracted width signal with a reference value concerning the width with respect to the assembled fiber band; an extracting means for extracting a stain signal from the video signal which may be clamped of the assembled fiber band (for example, a differentiation means for differentiating the video signal which may be clamped), and a stain distinction means for distinguishing suitability or acceptability of the stain by comparing the extracted stain signal (for example, the differentiated video signal which may be clamped) with a reference value with respect to the stain of the assembled fiber band.

Furthermore, the system of the present invention may comprise a thickness distinction means which eliminates noise from the video signal which may be clamped of the assembled fiber band, extracts a thickness video signal, and distinguishes suitability of the thickness by comparing the extracted thickness video signal (or a fluctuation value of the video signal) with a reference value with respect to the thickness of the assembled fiber band (e.g., an upper limit reference value and a lower limit reference value by means of a window comparator); an extracting means which eliminates noise from the video signal which may be clamped of the assembled fiber band and generates a rectangular signal corresponding to the width of the assembled fiber band, a counter means for counting rectangular sections of the video signal which may be clamped on the basis of a clock means, a width distinction means for distinguishing suitability of the width by comparing the count value obtained from the counter means with reference values with respect to the width of the assembled fiber band; a differentiation means for differentiating the video signal which may be clamped of the assembled fiber band, a comparing means for distinguishing a stain by comparing the differentiated video signal obtained by the differentiation means with reference values with respect to the stain of the assembled fiber band, a counter means for counting the number of stains on the basis of both the defect information with respect to the stain from this comparing means and the information with respect to the image width from the line sensor, and a stain distinction means for distinguishing suitability or acceptability of the stain by comparing the count data counted by the counter means with a reference value with respect to the stain of the assembled fiber band. In this system, the comparing means may comprise a first comparing means for distinguishing a larger stain by comparing the differentiated video signal and a first reference value with respect to stain largeness of the assembled fiber band, and a second comparing means for discriminating a smaller stain by comparing the differentiated video signal and a second reference value with respect to stain smallness of the assembled fiber band. Furthermore, the counter means may comprise a first counter means for counting the number of large stains on the basis of both the defect information with respect to the stain from the first comparing means and the information with respect to the image width from the line sensor, and a second counter means for counting the number of small stains on the basis of both the defect information with respect to stains from the second comparing means and the information with respect to the image width from the line sensor. Furthermore, the stain distinction means may distinguish suitability or acceptability of the stain by comparing the count data counted by the first counter means and reference values with respect to large stains of the assembled fiber band.

Furthermore, the distinction system of the present invention may comprise a transmitting means for supplying the characteristic information [for example, at least one characteristic information selected from a width count data (a count data with respect to the width), a thickness video signal (a video signal with respect to the thickness extracted from the video signal which may be clamped), and a stain count data (a count data with respect to the stain)] to a process control computer (or an external computer). It is not necessary that the distinction system of the present invention have an A/D conversion means (an A/D converter) for converting a video signal as an analog signal into a digital signal. It is also not necessary that the distinction system have a means for functioning as a computer, for example, a storage means (a memory) for storing a digitized clamped video signal (or video image signal)[for example, a one-dimensional memory (e.g., a line memory), and a two-dimensional memory (e.g., a frame memory)] or a central processing unit (CPU) containing a computing means. The distinction system may function as a pre-processing unit for processing by an external computer. Therefore, it is not necessary to have a program for functioning as a computer. That is, the auto distinction system of the present invention may, without using a memory (e.g., a frame memory), sequentially detect or extract and distinguish a video signal containing a one-dimensional information obtained by each scanning to send the detected characteristic information or the extracted or distinguished defect information to a following external computer such as a process control computer.

Incidentally, for the characteristic information with respect to the width and the characteristic information with respect to the stain, it is not necessary to have a storage means (a memory), a computing means and a central processing unit. For the characteristic information with respect to the thickness, although it is useful to employ a computer having a storage means (a memory), a computing means and a central processing unit for analysis with a high degree of accuracy, such a computer is not necessarily needed.

As the stain count data, a data concerning the above-mentioned stains (large stain count data and/or small stain count data) can be used. This transmitting means may comprise an interface means for transmitting or transferring the characteristic information (at least one characteristic information selected from a width count data, a thickness video signal, and a stain count data) to a computer, and a trigger means for generating a trigger signal to provide the transferring timing of the characteristic information to a process control computer (or an external computer) via the interface means. When such a transmitting or transferring means is provided, a characteristic information including a defect information with respect to at least one characteristic selected from a thickness, a width, and a stain of the assembled fiber band can be used as a time sequence fluctuation information (time-series fluctuation information) and can be used for process control or quality control by a process control unit.

The present invention also includes an auto distinction method which comprises imaging a continuously moving assembled fiber band by a line sensor, extracting a detect information concerning at least one characteristic selected from the group consisting of a width, a thickness, and a stain of the assembled fiber band from a characteristic information based on a video signal from the line sensor, and distinguishing (or discriminating) suitability of the defect information based on the extracted signal and a reference signal with respect to the information (the extracted or detected characteristic information or the defect information). In the method, the video signal from the line sensor may be clamped, and the defect information of the assembled fiber band may be extracted based on the clamped video signal.

The video signal from the line sensor may be a video signal obtained by scanning at predetermined time intervals (periodically). The video signal, which may be clamped, may contain a one-dimensional information corresponding to one scanning by the line sensor, and each of the one-dimensional informations may be dispersed or separated. Therefore, each of the one-dimensional informations from the line sensor forms a time-series fluctuation information. Since the auto distinction system of the present invention has no memory for storing a scanned one-dimensional information, the system forms (or produces) no image information of a two-dimensional area of the scanned assembled fiber band. Each scanning of the line sensor corresponds to a scanning line unit [e.g., the unit is composed of one or plural number (about 2 to 10) of scanning line(s)] of a number of scanning lines from an area sensor. Accordingly, even in the case where each of the one-dimensional informations is assembled, there is a high resolution in the scanning direction (in the scanning line) and there is a low resolution or no resolution in the running direction (a direction perpendicular to the scanning direction) of the assembled fiber band. Therefore, an image information of a two-dimensional area of the scanned assembled fiber band does not formed (or produced).

In this specification, “characteristic information” or “defect information” is sometimes just referred to as “information”.

### EFFECTS OF THE INVENTION

In the present invention, since a characteristic information (defect information) about an assembled fiber band can be efficiently extracted, even from a continuously moving assembled fiber band, the quality of the assembled fiber band can be accurately distinguished with time by accurately extracting the defective portions or the uneven portions of the assembled fiber band. Moreover, the present invention ensures to detect not only a single characteristic of the assembled fiber band, but also a defect information with respect to at least two characteristics selected from a width, a thickness, and a stain. Furthermore, even in the case of a band-shaped assembled fiber band such as a filter tow which moves at a high speed, fluctuations in width and thickness and stains can be efficiently detected. Furthermore, not only can defective portions be distinguished by the system by itself, but also the characteristic information is sent to a computer (for example, a process control computer) and analyzed by the computer as a time sequence fluctuation information, whereby the information can be used for process control and quality control at a production site (point of production).

Further, since the system can process the video signal as an analog signal, it is unnecessary to digitize the signal by an A/D conversion means and it is unnecessary to have a memory for temporarily storing the video signal. Moreover, two thresholds for the analog signal are set by electronic circuits of the system to perform such a distinction that a signal is not considered as a measuring object when the signal is over either of the thresholds, with a high speed in real time. In addition, an advanced processing such as selection and sorting of a measuring object can be conducted. Further, the result of distinction can be informed the outside. Furthermore, an improved distinction can be realized without using a computer.

### BRIEF DESCRIPTION OF THE DRAWINGS

FIG. 1 is a block diagram showing an example of the electrical construction of the system of the present invention.

FIG. 2 is a schematic layout drawing of the system of FIG. 1.

FIG. 3 is a flowchart for illustrating operations of the system of FIG. 1.

FIG. 4 is a block diagram showing another example of the electrical construction of the system of the present invention.

FIG. 5 is a schematic layout drawing of the system of FIG. 4.

FIG. 6 is a flowchart for illustrating operations of the system of FIG. 4.

FIG. 7 is a block diagram showing still another example of the electrical construction of the system of the present invention.

FIG. 8 is a schematic layout drawing of the system of FIG. 7.

FIG. 9 is a flowchart for illustrating operations of the system of FIG. 7.

FIG. 10 is a block diagram showing another example of the electrical construction of the system of the present invention.

FIG. 11 is a schematic layout drawing of the system of FIG. 10.

FIG. 12 is a flowchart for illustrating operations of the system of FIG. 10.

FIG. 13 is a block diagram showing further another example of the electrical construction of the system of the present invention.

FIG. 14 is a flowchart for illustrating operating procedures when the system of FIG. 13 is activated.

FIG. 15 is a graph showing time sequence fluctuations of a characteristic information of a cigarette filter tow which continuously moves or runs.

FIG. 16 is a block diagram showing an example of process control using the auto distinction system of the present invention.

### DETAILED DESCRIPTION OF THE INVENTION

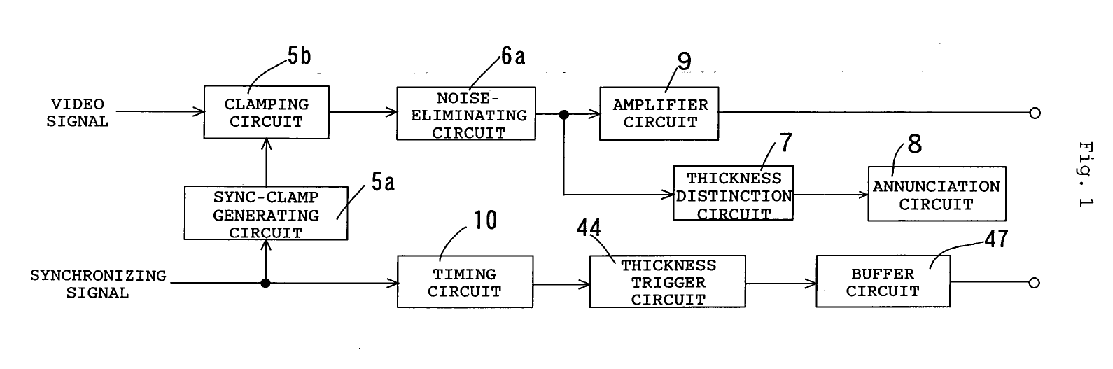

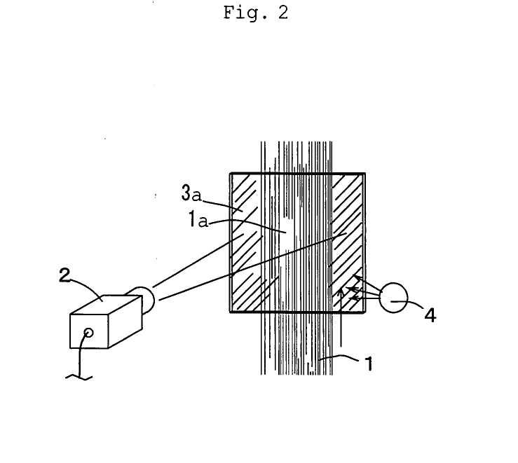

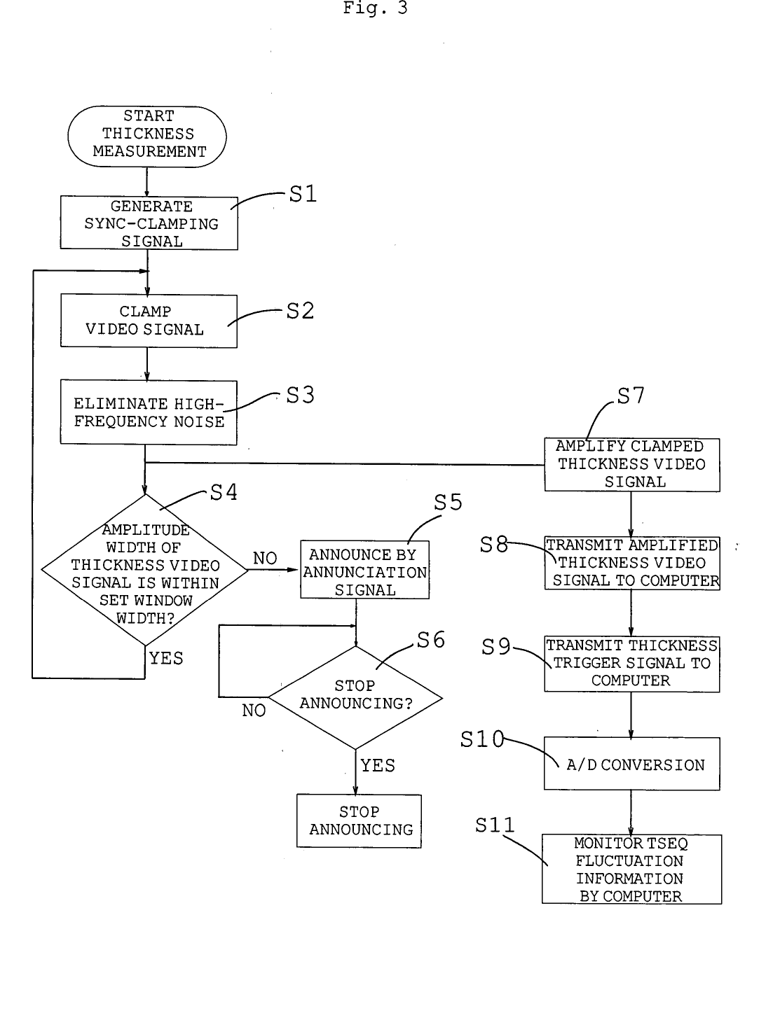

FIG. 1 is a block diagram showing an example of the electrical construction of the system of the present invention, FIG. 2 is a schematic layout drawing of the system of FIG. 1, and FIG. 3 is a flowchart for illustrating operations of the system of FIG. 1. In this example, thickness (or uneven thickness) of a filter tow (a band-shaped tow) which continuously moves is detected. The filter tow (or the tow band) comprises a plurality of yarns. Namely, the filter tow is formed of a plurality of yarns which are bundled, adjacently arrayed each other and overlapped to form a layer form. Therefore, the degrees of adjacency and overlapping of the yarns fluctuate while yarns are moving, and unevenness in thickness of the filter tow easily generates a defective product.

As shown in FIG. 2, on the foreside of a filter tow 1 which is continuously moving from the lower side to the upper side, a line sensor (imaging means) 2 is disposed with a predetermined angle of view, and on the backside of the filter tow 1, a black background plate 3a is disposed for increasing the contrast to the white tow. In an out-of-view field range of the line sensor 2, an illumination unit 4 for illuminating the filter tow 1 from an oblique direction is disposed on the backside of the filter tow 1. Namely, the illumination unit 4 is disposed so as to face the backside of the filter tow 1 from the background plate 3a, and illuminates (or permeably illuminates) the backside of the filter tow 1 with light beams. Therefore, by means of the difference of light transmittances in the filter tow 1, namely high light transmittance in a thin area 1a and low light transmittance in a thick area, the thickness (or the thinness) of the filter tow 1 can be imaged with high contrast and the evenness or the unevenness in thickness thereof can be extracted or detected with high accuracy.

The scanning by the line sensor can be conducted with corresponding to one line in a specific visual field (area or region) of a continuously moving assembled fiber band, and one or a plurality of scanning(s) can be conducted in association with the running speed of the assembled fiber band for each visual field. The video signal by such a scanning can be utilized for efficiently extracting the defect information about the assembled fiber band for each scanning to distinguish the defect information with a high degree of accuracy, and the defect information is available as a time-series data.

The video signal from the line sensor corresponds to one line (scanning line) of an image which crosses the assembled fiber band toward a width direction thereof (a direction perpendicular to the running direction in the plane of the assembled fiber band), and contains a signal of a non-image section (a section which do not contains an image signal) and a signal of an image section (a section which contains an image signal).

In the case where the line sensor is self-excited, in addition to a video signal, a synchronizing signal is also sent from the line sensor. In the case where the line sensor is separately-excited, in response to a clock pulse sent from a synchronizing signal generating circuit and a synchronizing signal for starting (activating) one-line scanning, an image is picked up and a video signal is generated.

The synchronizing signal from the line sensor or the synchronizing signal generating circuit is supplied to a sync-clamping signal generating circuit 5a, and a sync-clamping signal generated from the sync-clamping signal generating circuit 5a is supplied to a clamping circuit 5b. This clamping circuit clamps the video signal in response to the sync-clamping signal, and makes the reference level constant. More specifically, since in a DC-coupled video signal the DC-level of the non-image section of the video signal by a circuit drift of the line sensor is not zero, the DC level of the image signal superimposed on the video signal is not also constant. Therefore, the sync-clamping signal generating circuit 5a generates a sync-clamping signal based on the synchronizing signal, and the video signal is clamped based on the sync-clamping signal, the DC level is regenerated to make the reference level constant. In the case where the line sensor is self-excited, the synchronizing signal sent from the line sensor may be utilized.

The signal of the image section (a luminance signal) of the video signal contains various information (characteristic information including defect information) with respect to the filter tow. In this example, since the characteristic information with respect to the thickness of the tow is usually contained in a clamped video signal (a video signal which is clamped) as a low frequency signal, the extracting means (or detection circuit or extraction circuit) comprises a high-frequency noise-eliminating circuit (low-pass filter circuit) 6a. That is, the clamped video signal contains noise (high-frequency noise) within the suitable or acceptable thickness range due to fine unevenness of fibers (or filaments) or yarns. Therefore, the clamped video signal (analog signal) is supplied to the noise-eliminating circuit (low-pass filter circuit) 6a for noise elimination without converting into a digital signal, and the video signal with respect to the thickness obtained by noise elimination (the thickness video signal) is supplied to a thickness distinction circuit 7 for comparing with reference values (each of thresholds of the lower and the upper limit of the thickness) with respect to the thickness of the filter tow. This thickness distinction circuit 7 comprises a window comparator, and generates an annunciation signal (or annunciating signal) when the signal level of the thickness video signal (fluctuation value) is out of a set (predetermined) window width. Namely, in the thickness distinction circuit (window comparator) 7, the lower limit reference value (lower limit threshold) and the upper limit reference value (upper limit threshold) regarding the thickness are compared with the thickness video signal (fluctuation value). When the thickness video signal level is equal to or lower than the lower limit threshold, or equal to or higher than the upper limit threshold, the distinction circuit 7 distinguishes that the tow is defective. When the thickness video signal level is equal to or lower than the lower limit threshold, or equal to or higher than the upper limit threshold, the thickness distinction circuit 7 sends an annunciation signal to an annunciation circuit (or annunciating circuit) 8 to announce (or signal) that an abnormality or a defect occurs in the thickness of the filter tow. These operations are performed without storing the video signal in the memory.

Incidentally, the thickness video signal, obtained from the clamped video signal by noise elimination, is amplified by an amplifier circuit 9 which forms an interface with the outside, and the amplified image signal is supplied to the process control computer (process control unit). That is, in response to various signals from the sync-clamping signal generating circuit 5a, a timing circuit 10 generates various timing signals from the video signal, and supplies the timing signals to a thickness trigger circuit 44. The thickness trigger circuit 44 is used for transmitting or transferring (data taking-in) the characteristic information (the amplified thickness video signal) to the computer via a buffer circuit 47 which forms an interface with the outside in order to supply a trigger signal to the computer. Incidentally, the thickness video signal (characteristic information signal) is analog-digital (A/D) converted and taken-in as a digital signal into the computer. Therefore, the time sequence fluctuation information (time-series fluctuation information) with respect to the thickness of the filter tow can be controlled by a computer, and can be utilized for process control and quality control in the manufacturing process of the filter tow. For example, on the basis of the level or the scale of the defect information, statistical data processing (time sequence fluctuation trend, generation frequency of the defect information (including the level and scale) and so on), the information can be utilized for control of the manufacturing process of the filter tow.

In the above-mentioned system, as shown in FIG. 3, when thickness measurement is started, a sync-clamping signal is generated based on a synchronizing signal in Step S1. Based on the sync-clamping signal, a video signal is clamped in Step S2, and a thickness video signal is extracted from the clamped video signal or detected therein by eliminating high frequency noise from the clamped video signal, and extracted as a defect information with respect to the thickness in Step S3. The clamped video signal (thickness video signal) from which noise has been eliminated is decided in Step S4 whether or not the amplitude width (width information) of the video signal with respect to the thickness is within the range of set window widths (reference values), and when the amplitude width is within the window width range, the process returns to the above-mentioned Step S1 and continues the same operation. On the other hand, when the amplitude width of the video signal is out of the set window width, an occurrence of a thickness abnormality or defect is announced (or informed) by an annunciation signal in Step S5, and it is decided in Step S6 whether or not to stop an alarm. When the decision to stop the alarm is not made, the alarm continues, and when the decision is made, the alarm ends.

The clamped video signal (thickness video signal) from which noise has been eliminated is amplified in Step S7. In Step S8, the amplified thickness video signal is transmitted to the computer, and in Step S9, a thickness trigger signal is supplied to the computer. For taking-in the thickness video signal into the computer, in Step S10, an analog signal is converted into a digital signal (A/D conversion), and in Step S11, the digitized thickness video signal is used as a time sequence (TSEQ) fluctuation information by the computer.

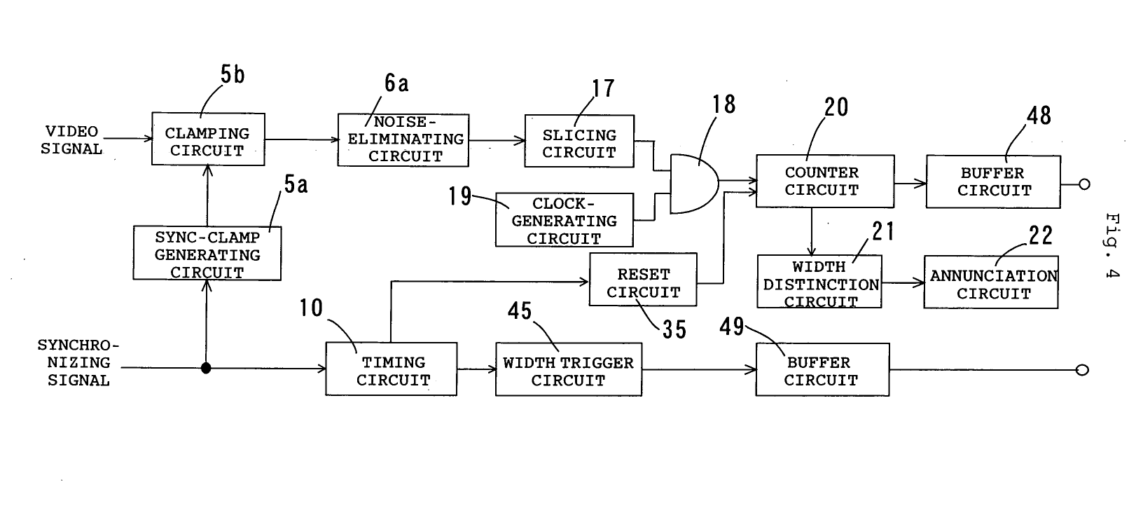

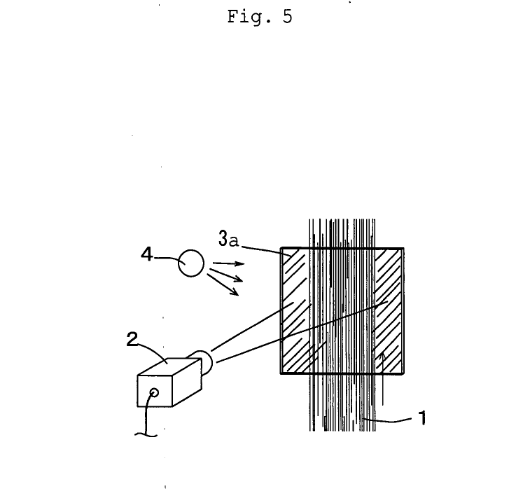

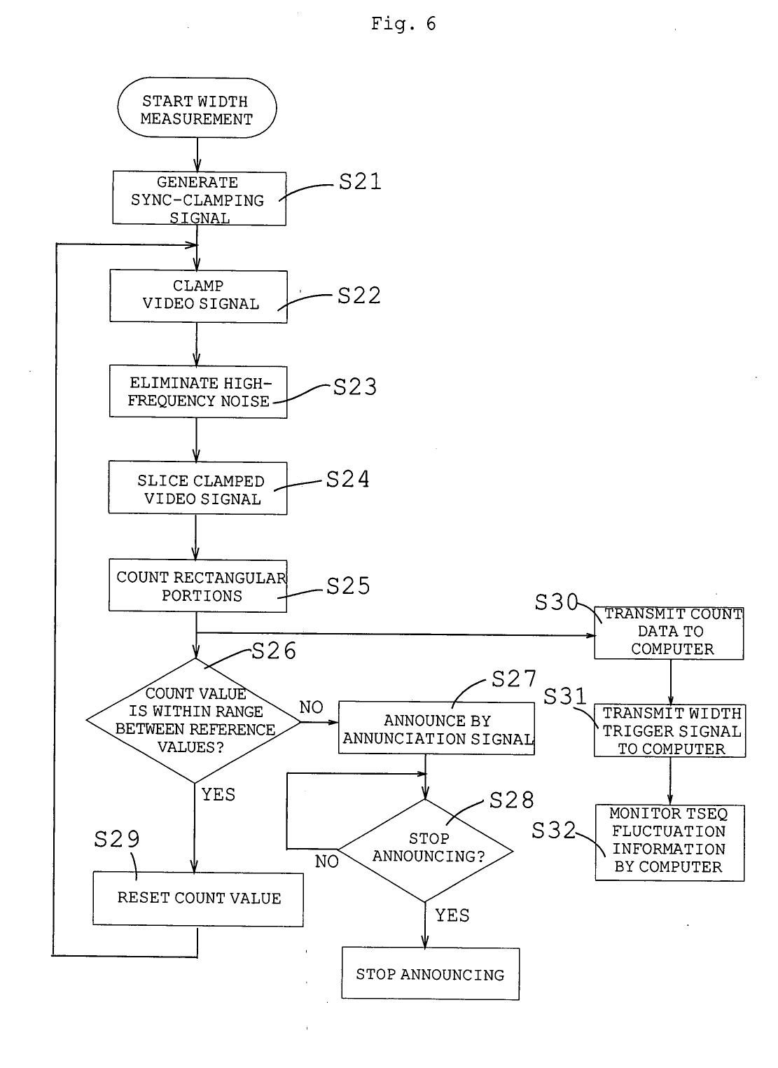

FIG. 4 is a block diagram showing another example of the electrical construction of the system of the present invention, FIG. 5 is a schematic layout drawing of the system of FIG. 4, and FIG. 6 is a flowchart for illustrating operations of the system of FIG. 4. In this example, width of a filter tow (band-shaped or ribbon-shaped tow) which continuously moves is detected.

As shown in FIG. 5, in this example, a background plate 3a and a line sensor 2 are disposed with respect to the filter tow 1 in the same manner as in FIG. 2 except that the illumination unit 4 is disposed on the side of the line sensor 2 (that is, the front side of the filter tow 1).

In response to a sync-clamping signal generated based on a synchronizing signal in a sync-clamping signal generating circuit (hereinafter, may be sometimes referred to as a sync-clamp generating circuit) 5a in the same manner as described above, a clamping circuit 5b clamps the video signal from the line sensor 2 and makes the reference level constant. Moreover, the synchronizing signal is also supplied to a timing circuit 10 for generating various timing signals.

The characteristic information with respect to the width of the tow is included in the clamped video signal as a low frequency signal. Therefore, in order to eliminate noise from the clamped video signal and extract the information with respect to the width of the tow, the video signal containing the characteristic information with respect to the width of the tow (the clamped video signal, the luminance signal) is set, without converting into a digital signal by an A/D conversion means and storing in a memory, to an extraction circuit comprising a noise-eliminatihg circuit (or a low-pass filter circuit) 6a for eliminating high frequency noise and a slicing circuit 17. The noise-eliminating circuit 6a eliminates noise contained in the clamped video signal (that is, noise signals which are out of the image signal, noise signals at the rising and falling points of the image signal, and noise signals which are in the image signal), and generates a video signal from which noise has been eliminated (a video signal with respect to the width of the tow). Furthermore, in order to extract a signal with respect to the width of the tow with higher accuracy, the video signal is supplied to a slicing circuit (or a comparison circuit or a comparing circuit) 17 with predetermined threshold set, and this slicing circuit 17 generates a rectangular signal sliced at a predetermined level corresponding to the width of the tow.

The noise-eliminated and sliced rectangular signal is supplied to an AND circuit 18, and a reference clock signal (pulse signal) from a clock-generating circuit (clock pulse-generating circuit) 19 is also supplied to this AND circuit. Therefore, the AND circuit 18 generates a clock signal (pulse signal) corresponding to the sliced rectangular wave field. The signal from the AND circuit 18 is supplied to a counter circuit 20, and the clock number (pulse number) corresponding to the width of the sliced rectangular wave is counted.

For resetting the count data counted by the counter circuit 20 for each imaging with the line sensor, the timing circuit 10 supplies a timing signal to a reset circuit (or a resetting circuit) (not shown), and this reset circuit resets the accumulated count data counted by the counter circuit 20 in response to the timing signal supplied from the timing circuit 10.

The count signal from the counter circuit 20 (the signal with respect to the width count data) is supplied to a width distinction circuit 21 for distinguishing suitability of the width of the filter tow by comparing the count signal with reference values with respect to the width of the filter tow. Incidentally, as reference values with respect to the width of the filter tow, a lower limit reference value (lower limit threshold) and an upper limit reference value (upper limit threshold) can be used, and when the count signal (width count data) is equal to or lower than the lower limit threshold or equal to or higher than the upper limit threshold, the width can be determined as defective, and suitability of the width is distinguished. When the width of the filter tow is determined as defective, the width distinction circuit 21 supplies an annunciation signal to an annunciation circuit 22 to announce that an abnormality or a defect with respect to the width of the filter tow has occurred.

Incidentally, the signal with respect to the width count data from the counter circuit 20 is supplied to the computer (an external computer such as a process control computer) via a buffer circuit 48 which forms an interface with the outside. To this computer, a trigger signal for taking-in data is supplied. Namely, the timing circuit 10 generates various timing signals. The timing signals from the timing circuit 10 are supplied to a width trigger circuit 45, and the width trigger circuit supplies a trigger signal to the computer via a buffer circuit 49 forming an interface with the outside, and this trigger signal is used for transmission or transfer (data taking-in) of the characteristic information (width count data) to the computer via the interface. That is, the time sequence fluctuation information (time-series fluctuation information) with respect to the width of the filter tow can be controlled by the computer, and can be used for process control and quality control in the manufacturing process of the filter tow. For example, based on fluctuation band with respect to the width, and statistical data processing (e.g., time-series fluctuation trend of width and generation frequency of the defect information), the information can be used for process control in the filter tow production.

In this system, as shown in FIG. 6, when width measurement is started, in Step S21a sync-clamping signal is generated based on a synchronizing signal, and in Step 22 a video signal is clamped based on the sync-clamping signal. In Step S23 high frequency noise is eliminated from the clamped video signal, and in Step S24 the video signal (clamped video signal) is sliced to extract the characteristic information about the width. The characteristic information (width of the sliced rectangular signal or the rectangular wave) extracted in Step 24 is counted on the basis of a reference clock signal in Step S25, and it is decided in Step S26 whether or not the count data is within the range between reference values (between upper limit and lower limit values). When the count data is out of the range between the reference values, an occurrence of an abnormality or a defect in the width is announced (or informed) by an annunciation signal in Step 27, and it is decided in Step S28 whether or not to stop an alarm. When the decision to stop the alarm is not made, the alarm continues, and when the decision is made, the alarm ends. On the other hand, when the count data is within the range between the reference values, the count data is reset to zero in Step S29 and the operation returns to the above-mentioned Step S21.

Furthermore, in Step S30, the count data counted in the above-mentioned Step S25 [the count data with respect to the width (width count data)] is transmitted or transferred to the computer, and in Step S31, a width trigger signal is supplied to the computer. In response to this trigger signal, in Step S32, the computer takes in the transmitted or the transferred count data, and monitors or analyzes the time sequence width fluctuation information (fluctuation information) based on the taken-in count data, and uses the count data for process control.

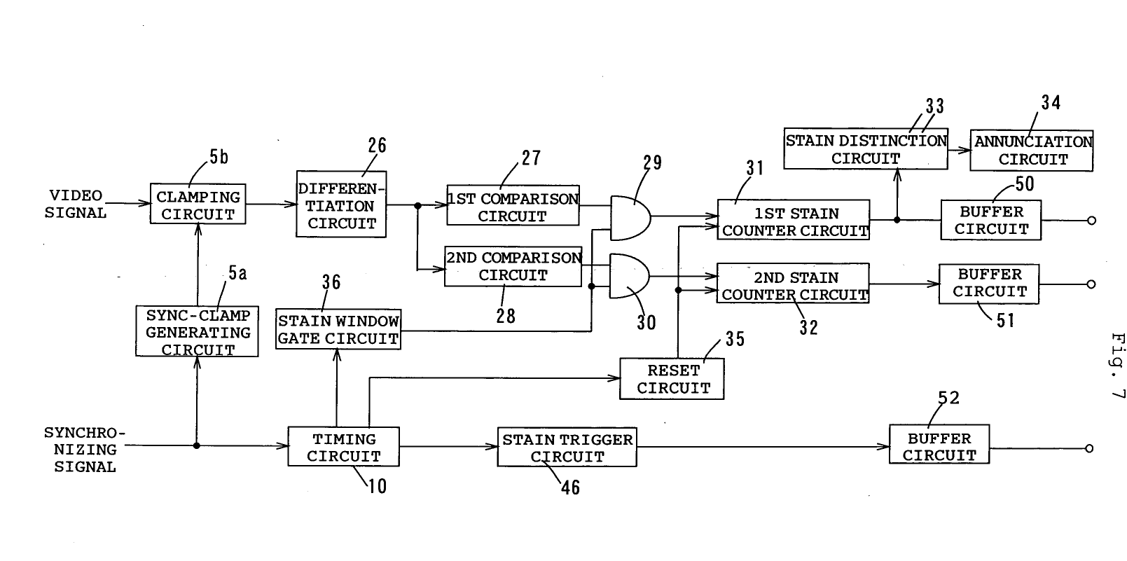

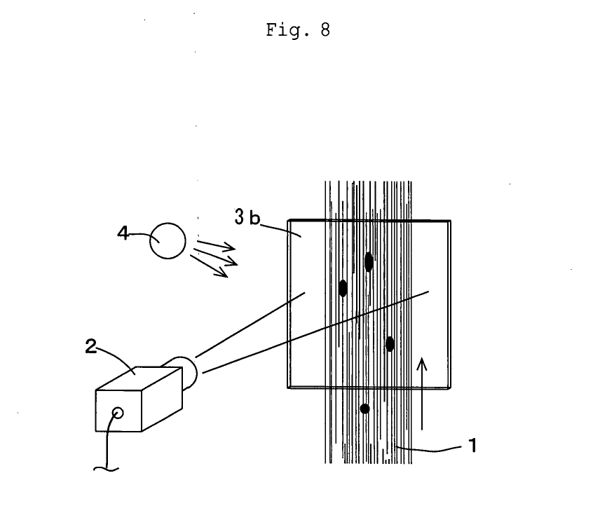

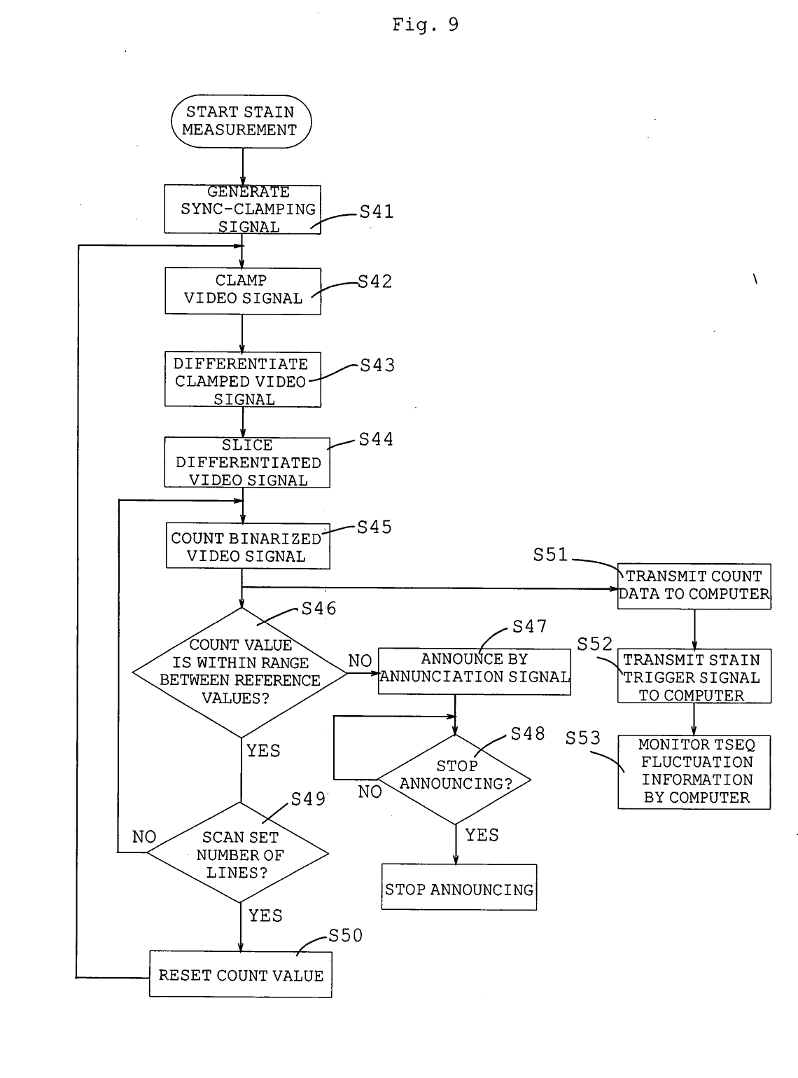

FIG. 7 is a block diagram showing still another example of the electrical construction of the system of the present invention, FIG. 8 is a schematic layout drawing of the system of FIG. 7, and FIG. 9 is a flowchart for illustrating operations of the system of FIG. 7. In this example, a stain on a filter tow (band-shaped tow) which continuously moves is detected.

As shown in FIG. 8, in this example, in order to efficiently extract a stain of the white filter tow 1 with preventing the stain extraction efficiency from declining due to shadow, a line sensor 2 and an illumination unit 4 are disposed in the substantially same way with FIG. 5 except that a background plate 3b having a color similar to (color similar in brightness or white) the color of the filter tow 1 is used.

As in the description given above, in response to a sync-clamping signal generated based on a synchronizing signal in a sync-clamping signal generating circuit 5a, a clamping circuit 5b clamps the video signal from the line sensor 2 and makes the reference level constant. Moreover, the synchronizing signal is supplied to a timing circuit 10 for generating various timing signals.

Stains of the tow are usually contained in the clamped video signal as a high frequency signal. Therefore, the clamped video signal (a luminance signal) is supplied to a differentiation circuit (or a differentiating circuit) 26 comprising a high-pass filter for eliminating low frequency noise without converting into a digital signal by an A/D conversion means and storing in a memory.

In order to extract the defect information with respect to stains on the tow, the clamped video signal is supplied to an extraction circuit which comprises a differentiation circuit 26, a comparison circuit 27, and an AND circuit 29. Namely, in the differentiation circuit 26, the clamped video signal is differentiated to eliminate low frequency noise, and the defect information about such as the stain is also converted into a peak waveform. The differentiated signal generated from the differentiation circuit 26 is supplied to a high level stain comparison circuit (first comparison circuit) 27 for slicing or comparing at a slice level (or a threshold, first reference value) with respect to a high level stain, and a low level stain comparison circuit (second comparison circuit) 28 for slicing or comparing at a slice level (or a threshold, second reference value) with respect to a low level stain, and the binarized signals are generated for stain detection. Incidentally, the high-level stain can be made to correspond to a value of a differentiated signal equivalent to an original stain of the filter tow, and the low-level stain can be made to correspond to a value of a differentiated signal equivalent to a latent stain of the filter tow.

The differentiated signal and the binarized signals from the differentiation circuit 26 sometimes contain binarized noise signals corresponding to shadows in both-side areas of the moving filter tow. Therefore, noise signals can be eliminated by generating a gate signal slightly narrower than the width of the moving filter tow and supplying this gate signal and the binarized signals to the AND circuits. In order to eliminate the noise signals, the signal from the first comparison circuit 27 and a tow width window gate signal from a stain window gate circuit 36 as the information with respect to the image width are supplied to a first AND circuit 29, and the signal from the second comparison circuit 28 and the tow width window gate signal from the stain window gate circuit 36 are supplied to a second AND circuit 30. The noise in the differentiated signal and the binarized signals from the differentiation circuit 26 is eliminated which corresponds to shadows on the both-side portions caused by the background plate. Incidentally, in the stain window gate circuit 36, a window is set which is slightly narrower than the set window width (observation width) of the filter tow, namely, a width reference value with respect to the window width which does not contain the noise, and the window gate signal from the stain window gate circuit 36 is supplied to the AND circuits 29 and 30 at a predetermined timing from the timing circuit 10.

The binarized signals from the first and second AND circuits 29 and 30 are supplied to stain counter circuits 31 and 32, respectively, and the number of pulses or rectangular peaks corresponding to stains in the binarized signals is counted. Incidentally, a count signal from the second counter circuit 32 is used for control of latent stains of the filter tow.

A count signal (signal with respect to the count data) from the first counter circuit 31 is supplied to a stain distinction circuit 33 for distinguishing suitability or acceptability of the stain by comparing with a predetermined reference value with respect to stains on the assembled fiber band, and when the degree of the stain (count number) becomes equal to or larger than the predetermined reference value, the stain distinction circuit 33 supplies an annunciation signal to an annunciation circuit 34 to announce that the stain on the filter tow is large.

For resetting count data of the first stain counter circuit 31 and the second stain counter circuit 32 for each predetermined number of the lines, the timing circuit 10 supplies a timing signal to a reset circuit 35, and the reset circuit responds to the timing signal from the timing circuit 10 so that the accumulated count data in the first and second counter circuits 31 and 32 is reset to zero.

Furthermore, the count signals from the first counter circuit 31 and the second counter circuit 32 are supplied to the computer via buffer circuits 50 and 51, respectively, and the buffer circuits form interfaces with the outside. Accordingly, the count signals are used for displaying the degree of the stain on a display or for process control of the filter tow. Namely, the timing circuit 10 generates various timing signals, and supplies the timing signals to a stain trigger circuit 46. This stain trigger circuit supplies, in response to the timing signals, a trigger signal to the computer via a buffer circuit 52 which forms an interface with the outside, and this trigger signal is used for transmission or transfer (data taking-in) of the characteristic information [the count data with respect to the stain (stain count data) or the count signal] to the computer via the interface.

In the distinction system, as shown in FIG. 9, a sync-clamping signal is generated based on a synchronizing signal in Step 41 in response to a start signal regarding stain measurement, and in Step 42 a video signal is clamped based on the sync-clamping signal.

The clamped video signal is differentiated in Step S43 for eliminating noise, and sliced and binarized in Step S44. In Step S45, the binarized video signals (pulses or rectangular peaks) are counted. It is distinguished whether or not the count signal (a signal with respect to the count data or the count data) is within the range of reference values in Step S46, and when the count data is out of the reference value range, an occurrence of an abnormality or a defect in a width is announced (or informed) by an annunciation signal in Step S47. In Step S48 it is decided whether or not to stop an alarm. When the decision to stop the alarm is not made, the alarm continues, and when the decision is made, the alarm ends. On the other hand, when the count data is within the range of reference values, it is distinguished whether or not the set number of scanning lines was scanned in Step S49, and when the set number of scanning lines was not scanned, the operation returns to Step S45 for counting the binarized signals, and after the set number of the scanning lines was scanned, the count data is reset to zero in Step S50.

Furthermore, in Step S51, the count data counted in Step S45 is transmitted or transferred to the computer, and in Step S52, a stain trigger signal is supplied to the computer. In Step S53, in response to this trigger signal, the transmitted or transferred count data are taken in into the computer, and monitors or analyzes the time sequence stain fluctuation information (fluctuation information) based on the taken-in count data, and uses the count data for process control.

Incidentally, in this flowchart, for the sake of convenience, the slicing with respect to the high level and the low level stains is described as a slicing in Step S44 as one step, and counting the number of high level and low level stains is described as counting the binarized signals in Step S45 as one step. Therefore, operation after Step S46 is carried out for both the high-level stain counting and the low-level stain counting.

Incidentally, in the above-mentioned example(s) the clamped video signal obtained by clamping the video signal from the line sensor is utilized. Since the video signal from the line sensor is usually DC-coupled, it is not necessarily required to clamp. Therefore, without clamping the video signal from the line sensor, the video signal which has not been clamped may be utilized for extraction of the defect information.

Moreover, in the above-mentioned example, a defect information (thickness, width, or stain) with respect to the moving filter tow is detected and it is distinguished whether the filter tow is non-defective or defective. According to the present invention, it is also ensured to distinguish whether the filter tow is non-defective or defective by extracting the defect information with respect to at least two characteristics of the thickness, width, and stain of the filter tow, for example, to distinguish whether the filer tow is non-defective or defective by extracting the defect information with respect to two characteristics of the thickness and width of the filter tow or with respect to two characteristics of the thickness and stain of the filter tow. Moreover, if necessary, it is ensured to distinguish whether the filer tow is non-defective or defective by extracting the defect information with respect to two characteristics of the width and stain of the filter tow.

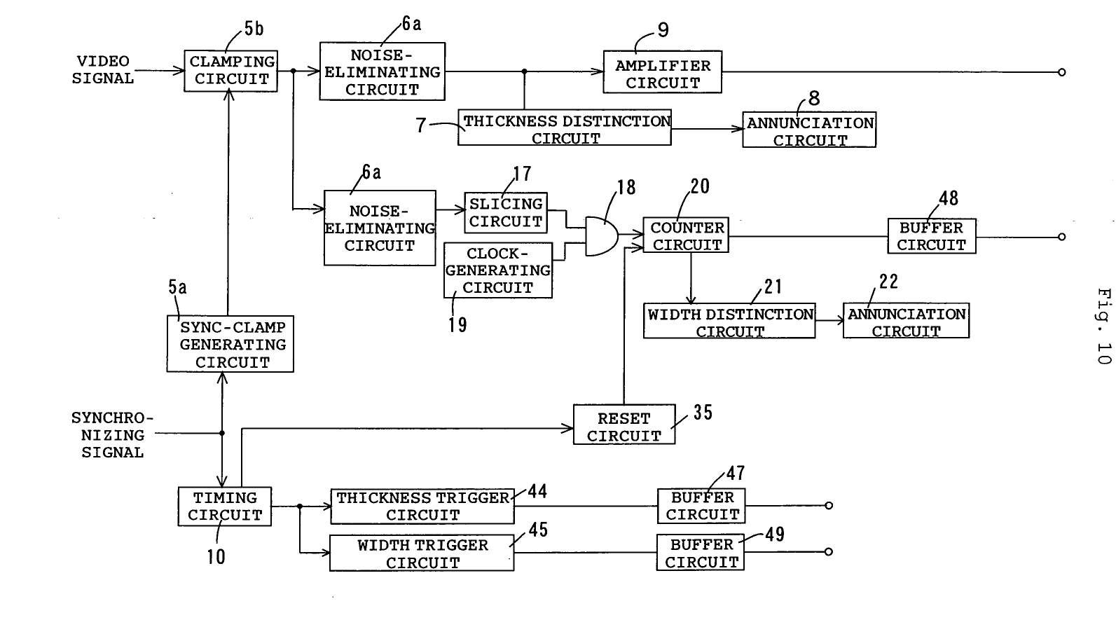

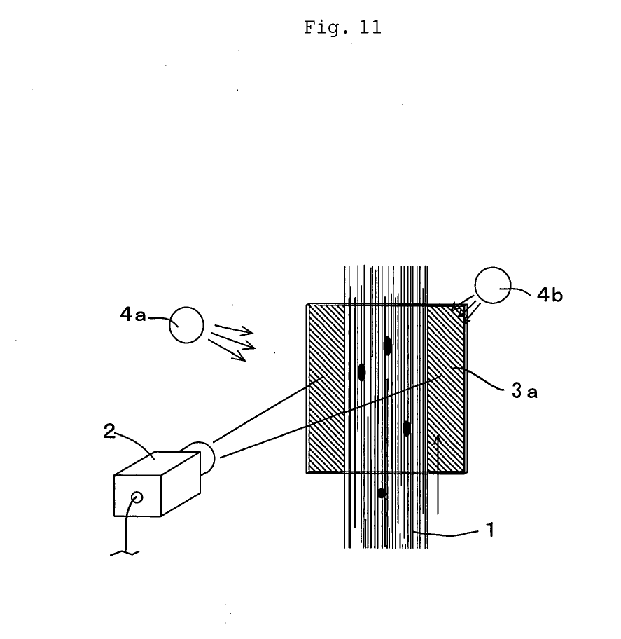

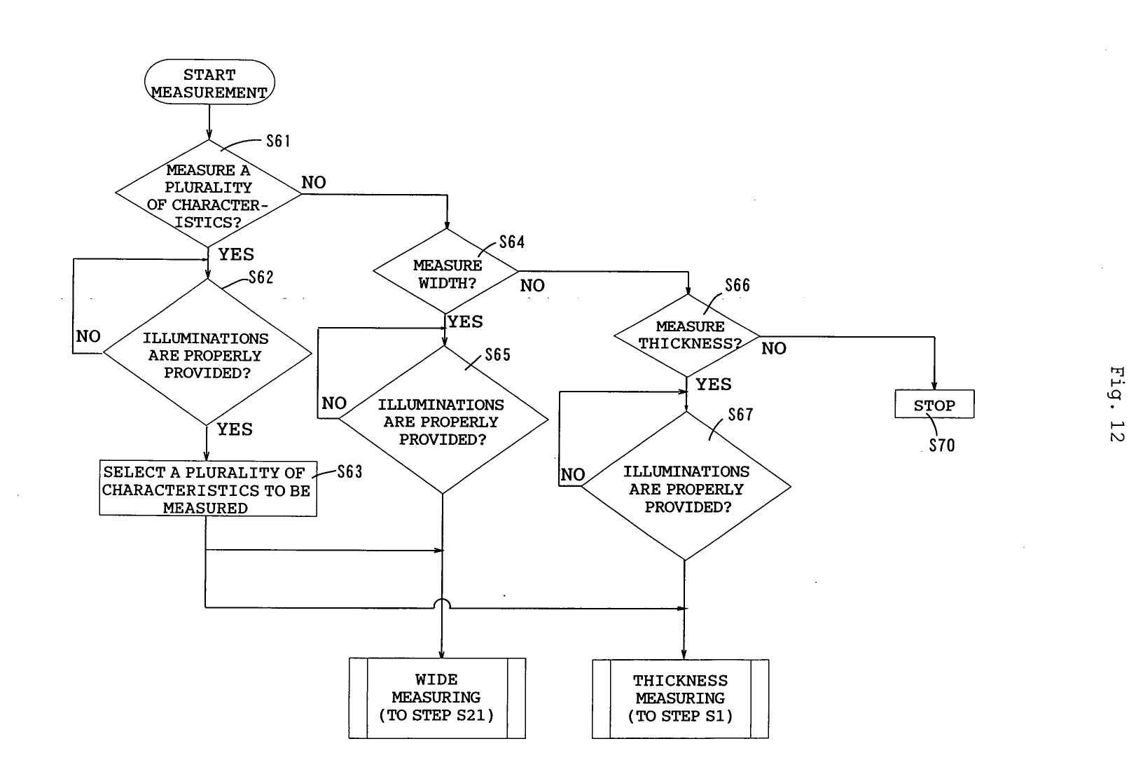

FIG. 10 is a block diagram showing another example of the electrical construction of the system of the present invention, FIG. 11 is a schematic layout drawing of the system of FIG. 10, and FIG. 12 is a flowchart for illustrating operating procedures when the system of FIG. 10 is activated. In this example, the thickness and width of a filter tow (band-shaped tow) which continuously moves are detected.

As shown in FIG. 11, in this example, a background plate disposed on the backside of the filter tow 1 comprises a background plate 3a having a high contrast to the filter tow 1. Incidentally, a line sensor 2 and an illumination unit 4a are disposed in the same positional relationship as in the above-mentioned FIG. 5, and an illumination unit 4b is disposed in the same positional relationship as in the above-mentioned FIG. 2.

As shown in FIG. 12, in this system, in response to measurement start signal, a mode select is required for selecting the characteristics of the filter tow to be measured. That is, in Step S61 it is required to select whether or not to measure a plurality of characteristics of the filter tow, and when it is selected to measure a plurality of characteristics, in Step S62, a distinction is required as to whether or not the illuminations or lightings (or the illumination units) have been properly disposed (for example, whether or not the front illumination and back illumination have been provided). When the illuminations are not properly disposed, it is required to set the illuminations properly. When the illuminations are properly set, it is required in Step S63 to select to measure a plurality of characteristics. When the thickness and width of the filter tow are selected, the operation proceeds to Step S1 shown in the above-mentioned FIG. 3 and Step S21 shown in FIG. 6, and measurement of each characteristic is started. On the other hand, when measurement of a plurality of characteristics is not selected in the above-mentioned Step S61, it is required to select whether or not to measure the width of the filter tow in Step S64, and in Step S64, when the width measurement is selected, it is required to distinguish whether or not the illuminations have been properly set, and when the illuminations are not properly set, it is required to properly set the illuminations. When the illuminations are properly set, the operation proceeds to Step S21 shown in the above-mentioned FIG. 6. On the other hand, when the width measurement is not selected in Step S64, it is required in Step S66 to select whether or not the thickness measurement of the filter tow. When the width measurement is selected in Step S66, it is required to distinguish whether or not the illuminations have been properly set. When the illuminations are not properly set, it is required to set properly the illuminations. When the background plate and the illuminations are properly set, the process transfers to Step S1 shown in the above-mentioned FIG. 3. Furthermore, when the thickness measurement is not selected in the above-mentioned Step S66, the measurement operation is stopped in Step S70. Incidentally, considering a case of erroneous inputs, it is possible to return to Step S61 again without stopping measurement in Step S70, or it is possible to provide a proper step for canceling the data which has been already input.

Incidentally, when a plurality of characteristics are not measured, the measurement order of the thickness and width of the filter tow is not particularly limited to a specific one, and the measurement order of the characteristics may be arbitrary. Incidentally, it is preferred that, as a selected mode, the width measurement mode precedes the thickness measurement mode for the sake of disposition of the illuminations.

As shown in FIG. 10, in response to a sync-clamping signal generated based on a synchronizing signal in a sync-clamping signal generating circuit 5a in the same manner as described above, a clamping circuit 5b clamps the video signal from the line sensor 2, regenerates the DC level of the video signal, and makes the reference level constant. The clamping of the video signal is not necessarily required. Moreover, the synchronizing signal is supplied to the timing circuit 10, and this timing circuit generates various timing signals for synchronizing with the video signal.

The clamped video signal generated from the clamping circuit 5b is supplied to the noise-eliminating circuit (low-pass filter circuit) 6a which constitutes an extraction circuit, and a clamped video signal (thickness video signal) from which noise has been eliminated is supplied to the thickness distinction circuit 7 for comparing with a lower limit reference value (lower limit threshold) and an upper limit reference value (upper limit threshold) with respect to the thickness, and this distinction circuit 7 distinguishes the filter tow as defective when the clamped video signal is equal to or lower than the lower limit threshold, or equal to or more than the upper limit threshold.

Moreover, in order to distinguish suitability of the width of the filter tow 1, as in the construction shown in the above-mentioned FIG. 4, the clamped video signal generated from the clamping circuit 5b is supplied to (1) an extraction circuit comprising a noise-eliminating circuit 6a and a slicing circuit 17, (2) an AND circuit 18 to which a clock signal (pulse signal) from the clock-generating circuit (clock pulse-generating circuit) 19 is supplied, (3) a counter circuit 20 and (4) a width distinction circuit 21 for distinguishing suitability of the width of the filter tow by comparing with reference values with respect to the width of the assembled fiber band. This distinction circuit supplies an annunciation signal to an annunciation circuit 22 for announcing that an abnormality or a defect in the width of the filter tow has occurred when the count value from the counter circuit 20 is equal to or lower than the lower limit reference value (lower limit threshold), or equal to or more than the upper limit reference value (upper limit threshold) with respect to the width of the filter tow.

The timing circuit 10 supplies various necessary timing signals to a thickness trigger circuit 44, a width trigger circuit 45, and a reset circuit 35.

Such a system realizes distinction of suitability of the filter tow regardless of the crimping of the filter tow, by efficient extraction of a plurality of characteristics with high accuracy.

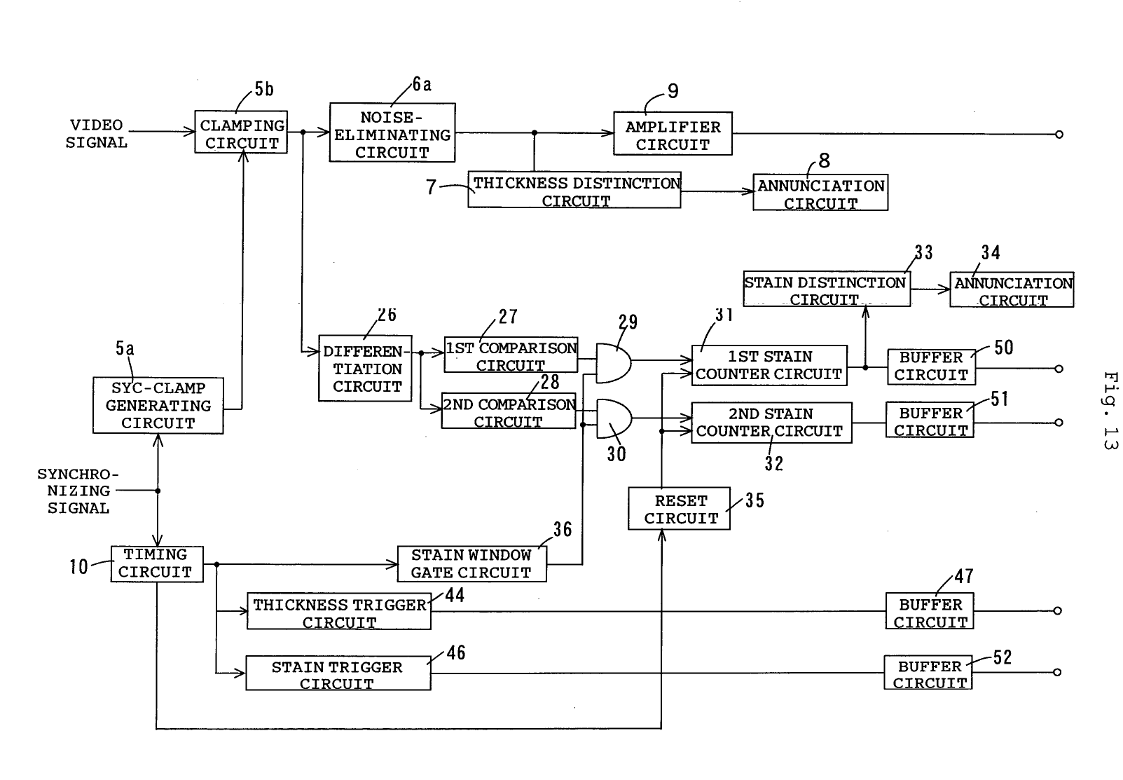

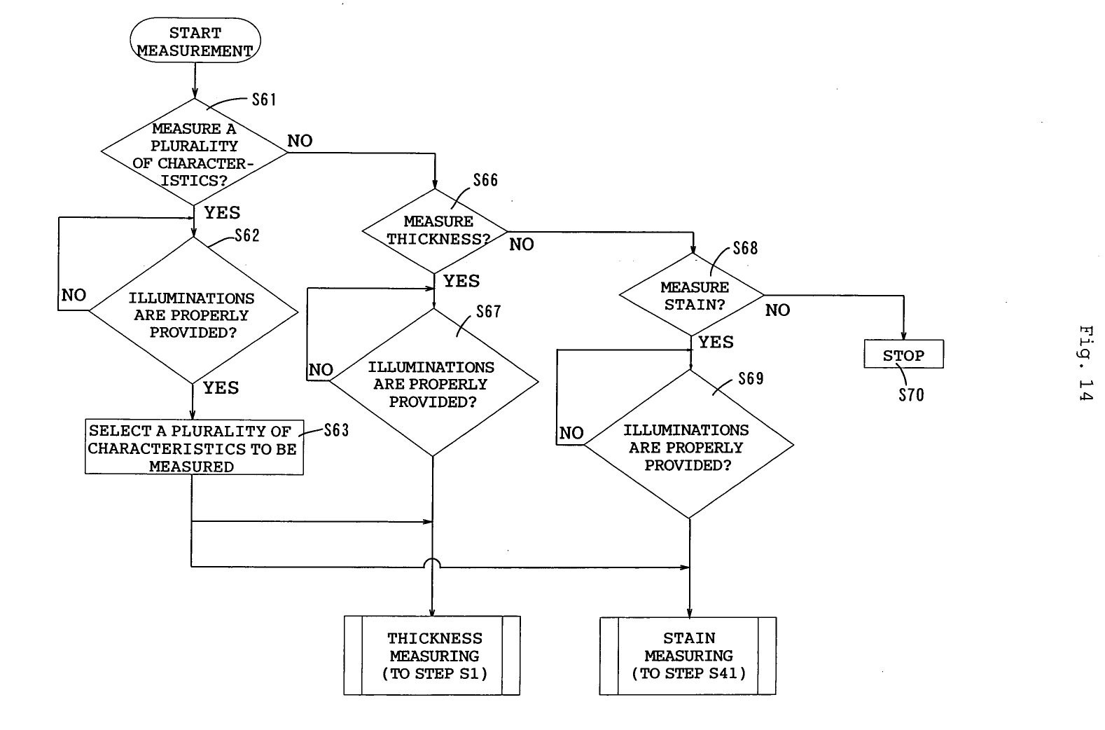

FIG. 13 is a block diagram showing another example of the electrical construction of the system of the present invention, and FIG. 14 is a flowchart for illustrating operating procedures when the system of FIG. 13 is activated. In this example, the thickness and stain of a filter tow (band-shaped tow) which continuously moves are detected. In this example, although the layout of the system is the same manner as in FIG. 11, the background plate has a color similar to (color similar in brightness or white) the color of the filter tow 1 in the same manner as the example of FIG. 8.

As shown in FIG. 14, in the system, in response to measurement start signal, a mode select is required for selecting the characteristics of the filter tow to be measured in the same manner as in the example of the FIG. 12. That is, in Step S61 it is required to select whether or not to measure a plurality of characteristics of the filter tow, and when it is selected to measure a plurality of characteristics, in Step S62, a distinction is required as to whether or not the illuminations (or the illumination units) have been properly disposed (for example, whether or not the front illumination and back illumination have been provided). When the illuminations are not properly disposed, it is required to set the illuminations properly. When the illuminations are properly set, it is required in Step S63 to select to measure a plurality of characteristics. When the thickness and stain of the filter tow are selected, the operation proceeds to Step S1 shown in the above-mentioned FIG. 3 and Step S41 shown in FIG. 9, and measurement of each characteristic is started. On the other hand, when measurement of a plurality of characteristics is not selected in the above-mentioned Step S61, it is required to select whether or not to measure the thickness of the filter tow in Step S66, and in Step S66, when the thickness measurement is selected, it is required to distinguish whether or not the illuminations have been properly set, and when the illuminations are not properly set, it is required to properly set the illuminations. When the illuminations are properly set, the operation proceeds to Step S1 shown in the above-mentioned FIG. 3. On the other hand, when the thickness measurement is not selected in Step S66, it is required in Step S68 to select whether or not the stain measurement of the filter tow. When the stain measurement is selected in Step S68, it is required to distinguish whether or not the illuminations have been properly set. When the illuminations are not properly set, it is required to set properly the illuminations. When the background plate and the illuminations are properly set, the process transfers to Step S41 shown in the above-mentioned FIG. 9. Furthermore, when the stain measurement is not selected in the above-mentioned Step S68, the measurement operation is stopped in Step S70. Incidentally, considering a case of erroneous inputs, it is possible to return to Step S61 again without stopping measurement in Step S70, or it is possible to provide a proper step for canceling the data which has been already input.

Incidentally, when a plurality of characteristics are not measured, the measurement order of the thickness and stain of the filter tow is not particularly limited to a specific one, and the measurement order of the characteristics may be arbitrary.

As shown in FIG. 13, in response to a sync-clamping signal generated based on a synchronizing signal in a sync-clamping signal generating circuit 5a in the same manner as described above, a clamping circuit 5b clamps the video signal from the line sensor 2, regenerates the DC level of the video signal, and makes the reference level constant. The clamping of the video signal is not necessarily required. Moreover, the synchronizing signal is supplied to the timing circuit 10, and this timing circuit generates various timing signals for synchronizing with the video signal.

The clamped video signal generated from the clamping circuit 5b is supplied to the noise-eliminating circuit (low-pass filter circuit) 6a which constitutes an extraction circuit, and a clamped video signal (thickness video signal) from which noise has been eliminated is supplied to the thickness distinction circuit 7 for comparing with a lower limit reference value (lower limit threshold) and an upper limit reference value (upper limit threshold) with respect to the thickness, and this distinction circuit 7 distinguishes the filter tow as defective when the clamped video signal is equal to or lower than the lower limit threshold, or equal to or more than the upper limit threshold.

Moreover, a clamped video signal generated from the clamping circuit 5b is supplied to an extracting or a detecting means similar to that of the above-mentioned FIG. 7 for extracting or detecting the stain of the filter tow 1. Namely, the clamped video signal from the clamping circuit 5b is supplied to (1) an extraction circuit which comprises a differentiation circuit 26 as a noise-eliminating circuit, a comparison circuit 27, and an AND circuit 29, (2) a high level stain comparison circuit (first comparison circuit) 27, a first AND circuit 29 and a first stain counter circuit 31 to which a tow width window gate signal is supplied from the stain window gate circuit 36, and (3) a low level stain comparison circuit (second comparison circuit) 28, a second AND circuit 30 and a second stain counter circuit 32 to which a tow width window gate signal is supplied from the stain window gate circuit 36; then (4) a stain distinction circuit 33 compares the count signal (signal with respect to the count data) from the first counter circuit 31 with a predetermined reference value with respect to a stain of the assembled fiber band in order to distinguish suitability or acceptability of the stain. When the degree (count number) of the stain is equal to or more than the predetermined reference value, the stain distinction circuit supplies an annunciation signal to an annunciation circuit 34. The count values accumulated in the first stain counter circuit 31 and the second stain counter circuit 32 are reset to zero by the reset circuit 35 in response to a timing signal from the timing circuit 10.

In response to the synchronizing signal, the timing circuit 10 supplies various necessary timing signals to the stain window gate circuit 36, the thickness trigger circuit 44, the width trigger circuit 45, the stain trigger circuit 46, and the reset circuit 35.

Such a system realizes efficient extraction both characteristics of the thickness and stain of the tow with a high degree of accuracy (or precision), regardless of crimping of the filter tow, by using a transmitted light for illuminating the filter tow from a backside thereof and a reflected light for illuminating the filter tow from a front side thereof with an illuminating means, and distinguishes suitability of the filter tow.

In the present invention, the illumination unit is not always necessary, however, the illumination unit is useful for enhancing the imaging contrast of the line sensor and the accuracy of detection of the defects of the assembled fiber band. The illuminating means may be disposed at a position outside of visual field (or out-of-view area or field) of the line sensor so as to illuminate the assembled fiber band, and the position where the illuminating means is disposed can be arbitrarily selected. For example, the assembled fiber band may be illuminated from the front side and/or the back side (for example, both the front and back sides) of the assembled fiber band, and the illuminating means may include transmitting (or permeating) light beams through the assembled fiber band. For example, in the example shown in FIG. 1 to FIG. 3, the explanation is given by using the illumination unit 4 which illuminates the filter tow 1 from the back side, however, it is also possible that the illumination unit 4 is set on the foreside of the filter tow 1. Moreover, the filter tow may be also illuminated from both the front and back sides of the filter tow by illumination units. Incidentally, a thickness defective portion of the assembled fiber band is usually detected by illuminating the assembled fiber band from the backside to the line sensor and using light transmitting (or permeating) through the assembled fiber band.

The background plate is not always necessary, either. The color and brightness of the background plate may be selected according to the type and color of the assembled fiber band or detection items, and the color of the background plate may have a different brightness and contrast from that of the assembled fiber band, or may have a brightness equivalent to or a color similar to that of the assembled fiber band (or may be a low-contrast color to that of the assembled fiber band). For example, a background plate for efficiently detecting or extracting the characteristic information with respect to the thickness is not limited to the black background plate 3a described in the above-mentioned FIG. 1 to FIG. 3, and the plate may have a color similar to that of the filter tow 1 (for example, a color having an equivalent brightness, or white). Incidentally, the background plate is usually formed to be larger than the moving width of the assembled fiber band.

Furthermore, in order to enhance the detection efficiency of a defective portion in the assembled fiber band which continuously moves, if necessary, a filter (color filter or the like) may be interposed between the assembled fiber band and the line sensor or a filter may be attached to the line sensor. For example, a color filter may be used to detect a colored defective portion.

As the line sensor can generate a video signal, and the video signal may be a color video signal or a monochrome video signal as long as the video signal contains a luminance signal. Incidentally, the color video signal (including a full color video signal) may be used after eliminating color signals (or chromatic signals) by a filter circuit.

Moreover, a stain is usually observed across a plurality of line scannings, and therefore, by determining whether or not the count number is a predetermined number by the stain distinction circuit 33 based on the characteristic information obtained (or the defect information) from the plurality of scannings (in particular, scannings adjacent or close (or neighboring) to each other), erroneous detection due to instantaneous noise (or a minute stain) can be prevented. For example, a circuit with the electrical construction shown in FIG. 7 (except for the annunciation circuit) is formed corresponding to each of the plurality of scannings (in particular, scannings adjacent or close to each other) including the characteristic information with respect to the stain. Further, a circuit is formed which comprises an AND circuit interposed between the plurality of stain distinction circuits 33 corresponding to each of the scannings and the single annunciation circuit 34. Then, according to the flow of FIG. 9, for the characteristic information about the respective scannings, binarized signals are counted in Step S45, and it is decided whether or not the count signals (count data) are within the reference value range in Step S46, and when the count data is out of the reference value range in Step S46, the count signals (or the count data) corresponding to each of the scannings are supplied to the AND circuit, and a signal from the AND circuit may be supplied to the annunciation circuit 34. In this example, the distinction circuit comprises a plurality of stain distinction circuits 33 and the AND circuit. In this process, the distinction circuit can effectively prevent erroneous detection and accurately detect stains because the circuit comprises a plurality of stain distinction circuits 33 and the AND circuit and distinguishes a stain when stain count signals are extracted from a plurality of scannings and stain count signals are extracted from each of the scannings.

Furthermore, even when a stain information (stain defect information, count signals) is detected in each of the scannings adjacent or close to each other, in some cases, it cannot be distinguished whether the stain information is obtained from one stain or a plurality of stains. Therefore, when the stain information (stain defect information, stain count signals) is detected in the respective scannings adjacent or close to each other, it may be determined whether the stain is singular or plural by distinguishing whether or not the stain count signals in the horizontal direction of the scannings adjacent or close to each other are at the same position. For example, with respect to a moving assembled fiber band, since a stain information is obtained from a plurality of scannings in many cases, when the stain signals are detected at the same position in the horizontal direction of the scannings adjacent or close to each other, the stain may be determined as a single stain.

As described above, from the viewpoint of preventing an erroneous detection due to instantaneous noise (or a minute stain) or the like, it is preferred to use the characteristic information from a plurality of scannings adjacent or close to each other. In the present invention, although a characteristic information with respect to the stain is detected in each one-dimensional information from each scanning, the system does not have a memory for storing the scanned one-dimensional information. Accordingly, it is difficult to form an image information about a two-dimensional area of the scanned assembled fiber band by assembling each one-dimensional information. Therefore, the video signal from the line sensor may contain a dispersed or separated one-dimensional information and may be a video signal obtained by scanning each scanning unit at predetermined time intervals (periodically) where the scanning unit is defined as one or a plurality [e.g., about 2 to 10 (particularly about 2 to 5)] of scanning(s) (for example, the predetermined number of scannings necessary for preventing the erroneous detection).

The extracting means for extracting defect or abnormal signals of the assembled fiber band from the clamped video signal is not particularly limited to a specific one, and may comprise various noise elimination means, for example, according to the type of a defect or an abnormal characteristic, the extracting means may comprise a differentiation means (or a differentiating means), an integration means, a means for comparing with thresholds, a waveform shaping means, and a slicing means by using thresholds, or may be formed by a combination of these means.

Moreover, in the above-mentioned example, a large stain and a latent stain are detected in stain detection. However, it is not necessary to detect a latent stain, and at least a stain except for latent stains may be detected. The signal with respect to a stain includes a signal with respect to the degree of stain and a signal with respect to the size of a stain area. Therefore, by using a combination of the differentiation circuit and the counter circuit and others, a signal with respect to a stain may be separated into a signal with respect to the degree of the stain and a signal with respect to a stain area, and the stain may be distinguished in the distinction circuit based on each of the signals. In addition, each of the signals may be accumulated (or added) and multiplied, and the stain may be distinguished by the distinction circuit Furthermore, in the above-mentioned example, defect(s) with respect to the thickness, width and/or stain of the assembled fiber band are detected, however, at least one characteristic of defective portion may be distinguished. Furthermore, in the distinction means, it is also possible to distinguish the quality of the assembled fiber band by multiplying the respective defective characteristics (thickness, width, and stain) by a weighting factor.

The annunciation (or informing) means is not always necessary, however, in many cases, an annunciation means (for example, a light emitting and a sound generation means such as a buzzer) is provided for annunciating an abnormal information on the basis of the distinction signal when the distinction signal from the distinction means which is out of a reference value range of the abnormal information.

The present invention is effective for quality control as well as non-defective or defective distinction of an assembled fiber band which is continuously manufactured. That is, in the present invention, the assembled fiber band is not particularly limited to a specific one as long as the assembled fiber band can continuously move. The assembled fiber band usually comprises yarns or strands formed by bundling a plurality of filaments (for example, about 100 to 10000 filaments, in particular, about 250 to 5000 filaments). The assembled fiber band may have a form extending in two-dimensional direction, for example, a band-shaped assembled fiber band or a bandage-shaped assembled fiber band. The assembled fiber band may be a band-shaped or a strip-shaped assembled fiber band comprising a plurality of yarns or strands, for example, a band-shaped assembled fiber band (band-shaped tow band) comprising a plurality of yarns which are bundled and adjacently arrayed each other, or a band-shaped assembled fiber band comprising a tow band (for example, a filter tow (cigarette or tobacco filter tow, etc.) and the like) in which yarns are adjacently arrayed each other and overlapped to form a plurality of layers. Yarns or strands adjacently arrayed each other may overlap each other, and in the band-shaped body in which the yarns or the strands are overlapped to form a plurality of layers, the yarns or the strands may be overlapped at the same position in the width direction, or may be overlapped each other while shifting their positions. For extracting or detecting a defective portion of the assembled fiber band by using transmitted light, the assembled fiber band may be a light transmittable assembled fiber band such as the filter tow (cigarette or tobacco filter tow or the like). Furthermore, the assembled fiber band such as tow may comprise non-crimped filaments (or non-crimped yarns or tow), or may comprise crimped filaments (or crimped yarns or tow). The present invention is effective for quality control, etc., in the manufacturing process of a filter tow for a cigarette or a tobacco.

Incidentally, the moving speed of the assembled fiber band is not particularly limited to a specific one, and may be, for example, about 0.1 to 100 m/sec, and preferably about 1 to 50 m/sec (for example, 5 to 30 m/sec).

In the assembled fiber band, because the degrees of proximity and overlapping of yarns adjacent to each other fluctuate with moving of the yarns, thickness and fiber density (filamentation state) easily fluctuate. In the present invention, even in the case of an assembled fiber band which moves at a high speed (a non-crimped or a crimped band-shaped filter tow, etc., made of a plurality of yarns), various defective portions (the defect information with respect to at least one characteristic selected from the width, the thickness, and the stain) can be extracted or detected with high accuracy by a detection means or a extracting (or extraction) means. Therefore, the present invention is useful for quality control of the assembled fiber band in the manufacturing and processing. Incidentally, in many cases of an assembled fiber band (filter tow, etc., before being crimped) made of a non-crimped filament (or non-crimped yarns or tow), a characteristic information with respect to at least one of the thickness, the width, and the stain is detected, and in many cases of an assembled fiber band (filter tow, etc., after being crimped) made of a crimped filament (or crimped yarns or tow), the characteristic information with respect to at least one characteristic of the width and stain is detected.

For example, in manufacturing of a crimped assembled fiber band (crimped filter tow, etc.), since overlapping states (evenness in thickness) of yarns (or bands) before and after being crimped can be distinguished, the distinguished state is effectively used for quality control of the assembled fiber band. Furthermore, defective portions (uneven portions of thickness, etc.,) of the assembled fiber band which cannot be detected by visual check during run of the band can be extracted or detected. Further, it can be distinguished whether or not the overlapping state (evenness in thickness) of yarns (or bands) before being crimped is the same as the initial setting state, or whether or not the overlapping state is in an allowable range. Therefore, by using the evenness in thickness as an index, the yarns (or the bands) can be supplied for the crimping process while the yarns (or bands) are overlapped with a predetermined evenness, whereby the entirety of the assembled fiber band can be crimped evenly. Furthermore, by controlling the width of the assembled fiber band, it can also be distinguished whether or not the center of the tow band before being crimped deviates from the center of a crimper. Therefore, the whole assembled fiber band can be evenly crimped by supplying the tow band with the position (or placement) of the center axis thereof as an index to the crimper. Furthermore, by detecting stains of the assembled fiber band, finished products can be effectively prevented from mixing with stained portions.

The present invention can be applied for process control or quality control by transmitting to a computer a characteristic information containing a defect information with respect to at least one characteristic selected from the group consisting of a width, a thickness, and a stain of an assembled fiber band which continuously moves as a time sequence or time-series fluctuation information. In particular, in the present invention, a transmitting means or a transfer means supplies at least one characteristic information selected from a width count data, a thickness video signal, and a stain count data to a process control computer, so that the characteristic information can be used as a time sequence or a time-series fluctuation information and can be effectively used for process control in the manufacturing process of the assembled fiber band and quality control of the assembled fiber band. As described above the transmitting means or the transfer means usually comprises an interface means (interface circuit) for transmitting or transferring to the computer at least one characteristic information selected from the width count data, the thickness video signal, and the stain count data, and a trigger means (trigger circuit) which generates a trigger signal for transmitting or transferring the characteristic information to the computer via this interface means. The trigger signal is used for providing (or announcing) the transfer timing of the characteristic information to the computer.

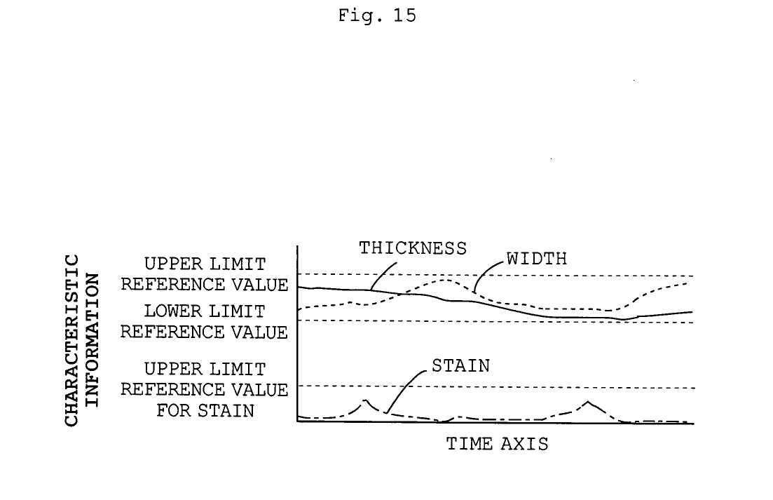

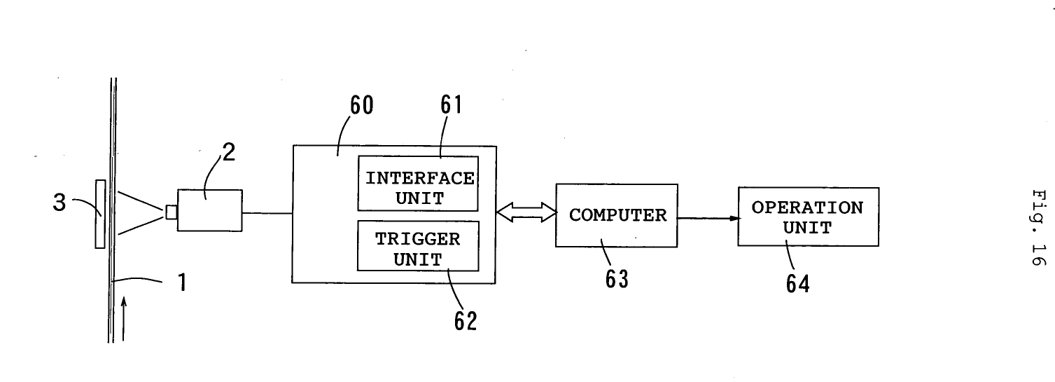

FIG. 15 is a graph showing time sequence fluctuations of the characteristic information about a cigarette filter tow which continuously moves, and FIG. 16 is a block diagram showing an example of process control using the auto distinction system of the present invention.

As shown in FIG. 15, the characteristics with respect to width, thickness, and stain of a continuously moving filter tow (band-shaped tow) fluctuate with time. For example, the width of the filter tow becomes narrower or wider with time, the thickness of the filter tow also becomes thicker or thinner in time series, and the stains of the filter tow increase or decrease with time. From these information, the defect information is extracted, and when the extracted signal is out of the reference value(s), an abnormality or a defect is announced (or informed) by an annunciation means, and the portion or the lot corresponding to the defect information of the filter tow is distinguished as defective. Therefore, the manufacturing operation rate and the yield of the filter tow decline, and the planned production volume cannot be achieved, and consequently, the manufacturing costs increase. On the contrary, the values of various characteristic information which is not distinguished as defective by the auto distinction system fluctuate within the thresholds (between the lower limit reference value and the upper limit reference value), and the fluctuation information (time sequence fluctuation information) includes useful information.

In FIG. 16, the filter tow 1 which moves on the foreside of the background plate 3 is imaged by a line sensor 2, and a video signal is transmitted to an auto distinction system 60, and in this system, the defect information is extracted from the information with respect to at least one characteristic selected from a width, a thickness, and a stain as described above, and it is distinguished whether or not the extracted signal is out of the reference values (the lower limit reference value and the upper limit reference value) by a distinction means. When a distinction signal is out of reference values with respect to a defect information, based on this distinction signal, the defect information is announced as an abnormality.

On the other hand, even when the defect information is not distinguished as an abnormality, the time-series characteristic information (fluctuation data) is data-transmitted to the computer 63 by the transmission or the transfer means (transfer means comprising an interface unit (interface circuit) 61 and a trigger unit (trigger circuit) 62) inside the auto distinction system 60. In the computer 63, trend analysis with respect to various characteristic information is respectively carried out based on the fluctuation data. According to the obtained trend, process control can be conducted by using the correlation between the controlled object and the controlled variable obtained from factor analysis, and automatically or manually operating the controlled object with the operation unit 64 in a production equipment. For example, even when the data value of the characteristic information (characteristic information on the thickness or the width) is within the range between the lower and the upper limit reference values, process control can be consistently made to maintain the data value of the characteristic information at the middle between the lower and the upper limit reference values.

The occurrence of abnormal products or defective products can be prevented by process control using a system comprising the auto distinction system and a separate computer (process control computer), and quality control of the filter tow can be effectively performed. Furthermore, while at least one characteristic information (processing condition) selected from the width, the thickness, and the stain of the filter tow (band-shaped tow) can be monitored in real time on the computer, a subsequent state can be predicted based on the time sequence trend of the characteristic information. Therefore, before the time sequence fluctuation value is below the lower limit reference value or over the upper limit reference value, occurrence of defective products can be prevented by operating the operation unit of the production equipment.

Incidentally, at least one characteristic information selected from the width count data, the thickness video signal, and the stain count data may be transmitted or transferred to the computer, or a plurality of characteristic information (characteristic information of the width and thickness, the width and stain, the thickness and stain, or the width, thickness, and stain) may be transmitted or transferred to the computer. The characteristic information to be transmitted or transferred to the computer may be a defect information. The characteristic information may be utilized as a time sequence fluctuation information (time series fluctuation information) by being transmitted or transferred to the computer one by one, and if necessary, stored in a storage circuit of the computer. The characteristic information may be used as a time sequence fluctuation information (time series fluctuation information) by being stored in the storage circuit of the distinction system for each predetermined scanning line, and being transmitted or transferred a plurality of the stored information to the computer. In the case where at least one characteristic information selected from the width count data, the thickness video signal, and the stain count data is used as a time sequence fluctuation information (time series fluctuation information) in the computer, all of the characteristic information contained in the predetermined line scanning may be supplied to the computer, or the characteristic information contained in the predetermined line scanning may be averaged and supplied to the computer. Moreover, the characteristic information of predetermined line scanning may be transmitted or transferred to the computer at a predetermined time interval.

In the interface circuit, various interfaces can be used according to the characteristics of the characteristic information (in particular, depending on whether the information is analog or digital). For example, a buffer circuit or the like can be used for digital signals such as the width count data, the stain count data, and the trigger signal, and an amplifier circuit or the like can be used for the video signal which may be clamped (thickness video signal or the like). The trigger circuit provides the transferring timing of the information (data or video signal) for the computer. Therefore, the characteristic information transmitted or transferred to the computer via the interface circuit is synchronized with the trigger signal from the trigger circuit and taken into the computer at a predetermined timing.

The auto distinction system of the present invention does not require any A/D conversion means which is used in a computer for converting a video signal (video image signal) into a digital signal and storage means (memory) which is used in a computer for storing a digitized video signal, and also does not require either a central processing unit (CPU) comprising a computing means or a program (software) for controlling a computer operation. For example, any A/D conversion means and storage means (memory) are not required in the auto distinction system of the present invention since a count data with respect to the width and a count data with respect to the stain are generated as digital signals without using an A/D conversion means and a storage means (memory).

Incidentally, the distinction system may have an analog/digital (A/D) conversion circuit to transmit or transfer the characteristic information (characteristic image signal) to the computer as a digital signal. The computer may have an analog/digital (A/D) conversion circuit to take-in the characteristic information (characteristic image signal) from the distinction system as a digital signal.

### INDUSTRIAL APPLICABILITY

The present invention can be utilized for distinguishing the quality of an assembled fiber band which continuously moves [for example, a band-shaped assembled fiber band such as a filter tow (e.g., a cigarette or a tobacco filter tow)] by extracting defective portions or uneven portions of the assembled fiber band.

1. An auto distinction system which is transmittable to a computer a characteristic information containing a defect information concerning at least one characteristic selected from the group consisting of a width, a thickness, and a stain of a continuously moving assembled fiber band as a time sequence or time-series fluctuation information, and which comprises
a line sensor for imaging the continuously moving assembled fiber band,
an extracting means for extracting the defect information from the characteristic information based on a video signal from the line sensor, and
a distinction means for distinguishing suitability of the characteristic or extracted information based on an extracted signal from the extracting means and a reference signal with respect to the characteristic or defect information.

2. An auto distinction system according to claim 1, comprising
a means for clamping the video signal from the line sensor, and
an extracting means for extracting the defect information concerning at least one characteristic selected from the group consisting of a width, a thickness, and a stain of the assembled fiber band based on a clamped video signal from the clamping means.

3. An auto distinction system according to claim 1, which has no central processing unit containing a memory for storing a digitized clamped video signal, and which is transmittable to the computer at least one characteristic information selected from the group consisting of a clamped video signal with respect to the thickness, a count data with respect to the width, and a count data with respect to the stain.

4. An auto distinction system according to claim 1, further comprising a transmitting means for supplying to a process control computer at least one characteristic information selected from the group consisting of a count data with respect to the width, a video signal with respect to the thickness, and a count data with respect to the stain.

5. An auto distinction system according to claim 4, wherein the transmitting means comprises
an interface means for transmitting or transferring to the computer at least one characteristic information selected from the group consisting of the count data with respect to the width, the video signal with respect to the thickness, and the count data with respect to the stain, and
a trigger means for generating a trigger signal to provide the transferring timing of the characteristic information to the computer via the interface means.

6. An auto distinction system according to claim 1, wherein the video signal, which may be clamped, contains a one-dimensional information corresponding to one scanning by the line sensor; and each of the one-dimensional informations is dispersed or separated in the form of a time-series fluctuation information, and forms no image information of a two-dimensional area of the assembled fiber band scanned by the line sensor.

7. An auto distinction system according to claim 1, wherein the video signal from the line sensor is a luminance signal.

8. An auto distinction system according to claim 1, comprising
an extracting means for extracting a low frequency signal of the video signal which may be clamped, and
a distinction means for distinguishing suitability of the thickness by comparing the low frequency signal with reference values with respect to the lower limit and the upper limit of the thickness.

9. An auto distinction system according to claim 1, comprising
an extracting means for eliminating a video signal with respect to the thickness by at least a noise elimination means, and
a distinction means for distinguishing suitability of the thickness by comparing the video signal with respect to the thickness with reference values with respect to the lower limit and the upper limit of the thickness.

10. An auto distinction system according to claim 9, wherein the noise elimination means is a means for eliminating high frequency noise.

11. An auto distinction system according to claim 1, wherein the assembled fiber band comprises a plurality of yarns which are bundled and adjacently arrayed each other, or a tow band in which yarns are adjacently arrayed each other and overlapped to form a plurality of layers.

12. An auto distinction system according to claim 1, further comprising
an illuminating means which is disposed outside of a visual field of the line sensor and illuminates the assembled fiber band, and
a background plate for forming the background against the assembled fiber band relative to the illuminating means.

13. An auto distinction system according to claim 12, wherein the background plate has a high contrast color to the color of the assembled fiber band, and the extracting means extracts the defect information with respect to at least one characteristic selected from the group consisting of the width and the thickness of the assembled fiber band by using a video signal corresponding to the high contrast color region.

14. An auto distinction system according to claim 12, wherein the background plate has a color being similar or low-contrast against the color of the assembled fiber band, and the extracting means extracts the defect information with respect to at least one characteristic selected from the group consisting of the stain and the thickness of the assembled fiber band by using a video signal corresponding to the similar color region.

15. An auto distinction system according to claim 1, wherein the assembled fiber band is a filter tow, and the extracting means extracts a defect information with respect to the width and the stain of the assembled fiber band, or a defect information with respect to the thickness and the stain of the assembled fiber band.

16. An auto distinction system according to claim 1, comprising
(a-1) an extracting means for extracting a thickness defect signal from the video signal, and (a-2) a thickness distinction means for distinguishing suitability of the thickness by comparing the extracted defect signal with a reference value with respect to the thickness of the assembled fiber band;
(b-1) an extracting means for extracting a width signal from the video signal, and (b-2) a width distinction means for distinguishing suitability of the width by comparing the extracted width signal with a reference value with respect to the width of the assembled fiber band; and
(c-1) an extracting means for extracting a stain signal from the video signal, and (c-2) a stain distinction means for distinguishing acceptability of the stain by comparing the extracted stain signal with a reference value with respect to the stain of the assembled fiber band.

17. An auto distinction system according to claim 1, comprising
a sync-clamping signal generating means for generating a sync-clamping signal based on a synchronizing signal from the line sensor or a synchronizing signal generating circuit;
a clamping means for clamping the video signal in response to the sync-clamping signal from the sync-clamping signal generating means;
(a-1) an extracting means for extracting a defect signal with respect to the thickness from the clamped video signal, and (a-2) a thickness distinction means for distinguishing suitability of the thickness by comparing the extracted defect signal with a reference value with respect to the thickness of the assembled fiber band;
(b-1) an extracting means for extracting a signal with respect to the width from the clamped video signal, and (b-2) a width distinction means for distinguishing suitability of the width by comparing the extracted width signal with a reference value with respect to the width of the assembled fiber band; and
(c-1) an extracting means for extracting a signal with respect to the stain from the clamped video signal, and (c-2) a stain distinction means for distinguishing acceptability of the stain by comparing the extracted stain signal with a reference value with respect to the stain of the assembled fiber band.

18. An auto distinction system according to claim 16, which comprises
(a-1) a thickness distinction means which eliminates at least high frequency noise from the video signal which may be clamped, detects or extracts a video signal with respect to the thickness, and distinguishes suitability of the thickness by comparing the detected or extracted video signal with a reference value with respect to the thickness of the assembled fiber band;
(b-1) an extracting means which eliminates noise from the video signal which may be clamped, and generates a rectangular signal corresponding to the width of the assembled fiber band, (b-2) a counter means for counting rectangular portions of the video signal by a clock means, and (b-3) a width distinction means for distinguishing suitability of the width by comparing the count data of the counter means with a reference value with respect to the width of the assembled fiber band; and
(c-1) a differentiation means for differentiating the video signal which may be clamped, (c-2) a comparing means for distinguishing a stain by comparing the differentiated video signal from the differentiation means with a reference value with respect to the stain of the assembled fiber band, and (c-3) a counter means for counting the number of stains on the basis of a defect information and an image-width information, in which the defect information relates to the stain from the comparing means and the image-width information relates to the image width from the line sensor, and (c-4) a stain distinction means for distinguishing acceptability of the stain by comparing the count data counted by the counter means with a reference value with respect to the stain of the assembled fiber band.

19. An auto distinction system according to claim 18, wherein the comparing means comprises a first comparing means for distinguishing a larger stain of the assembled fiber band by comparing the differentiated video signal with a first reference value with respect to stain largeness, and a second comparing means for distinguishing a smaller stain of the assembled fiber band by comparing the differentiated video signal with a second reference value with respect to stain smallness;
the counter means comprises a first counter means for counting the number of large stains on the basis of both the defect information with respect to the stain from the first comparing means and the image-width information from the line sensor, and a second counter means for counting the number of small stains on the basis of both the defect information with respect to the stain from the second comparing means and the image-width information from the line sensor; and
the stain distinction means distinguishes acceptability of the stain by comparing the count data counted by the first counter means with a reference value with respect to large stain of the assembled fiber band.

20. An auto distinction system according to claim 1, wherein the extracting means extracts the defect information with respect to at least one characteristic selected from the group consisting of a width, a thickness, and a stain of a crimped or non-crimped band-shaped filter tow which continuously moves and comprises a plurality of yarns.

21. An auto distinction method which is transmittable to a computer a characteristic information containing a defect information concerning at least one characteristic selected from the group consisting of a width, a thickness, and a stain of a continuously moving assembled fiber band as a time sequence or time-series fluctuation information, and which comprises
imaging a continuously moving assembled fiber band by a line sensor,
extracting the detect information from the characteristic information based on a video signal from the line sensor, and
distinguishing suitability of the defect information based on the extracted signal and a reference signal with respect to the characteristic or defect information.

22. An auto distinction method according to claim 21, wherein the video signal from the line sensor is clamped based on a sync-clamping signal generated from a synchronizing signal, and the defect information concerning at least one characteristic selected from the group consisting of a width, a thickness, and a stain of the assembled fiber band is extracted based on the clamped video signal.

23. An auto distinction method according to claim 21, wherein the video signal, which may be clamped, contains a one-dimensional information corresponding to one scanning by the line sensor; and each of the one-dimensional informations is dispersed or separated in the form of a time-series fluctuation information, and forms no image information of a two-dimensional area of the assembled fiber band scanned by the line sensor.
